(19) United States
(12) Patent Application Publication
(10) Pub. No.: US 2026/0286775 A1
(43) Pub. Date: Sep. 24, 2026

(54) TEMPORARY GATE ASSEMBLY

(71) Applicant: VORP Energy International LLC, Rexburg, ID (US)

(72) Inventors: Justin Gant, Lynnwood, WA (US); Michael Stilwell, Lynnwood, WA (US)

(21) Appl. No.: 19/545,716

(22) Filed: Feb. 20, 2026

Related U.S. Application Data
(60) Provisional application No. 63/761,476, filed on Feb. 21, 2025.
(60) Provisional application No. 63/761,469, filed on Feb. 21, 2025.

(51) Int. Cl. E06B 11/02; E04H 17/18; E04H 17/22

(52) U.S. Cl. CPC E06B 11/022; E04H 17/18; E04H 17/22

(57) ABSTRACT

A temporary gate module for a temporary barrier system may include a temporary gate unit, and one or more ballast units fixedly coupled to the temporary gate unit, the one or more ballast units comprising: a base portion, at least one lifting feature defined along a bottom of the base portion, a plurality of guide posts disposed along a top of the base portion, and a mounting bracket detachably coupling the base portion to the temporary gate unit. A temporary barrier system may include one or more temporary gate modules, one or more temporary ballast assemblies, one or more temporary barrier posts, one or more temporary barrier panels, and one or more clips configured to couple the one or more temporary barrier panels to the one or more temporary barrier posts.

### CROSS REFERENCE TO RELATED APPLICATIONS

This application claims priority to Provisional Application No. 63/761,476 filed Feb. 21, 2025, and Provisional Application No. 63/761,469 filed Feb. 21, 2025, the entire disclosures of which are hereby incorporated by reference.

### BACKGROUND

With changes in technology and consumer demand, increasing numbers of locations require access restrictions to maintain a secure environment. These locations can vary widely, including industrial facilities, manufacturing spaces, distribution centers for processing shipping and logistics, and event spaces for high-profile media events. Each of these locations and more may require access both to pedestrians and to vehicles and thus require access points through the security system. While in the past, the relative centralization of facilities requiring increased security meant that security logistics planners could rely on permanent security installations, complete with gate houses and permanent access points, today these types of activities are more likely to pop up quickly and require rapid deployment of security operations, such as a barrier system. However, typical permanent security perimeter barrier systems require extensive anchoring to the ground-particularly to support any type of secure gate- and this type of anchoring will typically require extensive permitting before it can be put in place, a regulatory process that can take six to twelve months or longer depending on the local rules.

Thus, traditionally, security personnel planning for a temporary or pop-up location requiring additional security will use quick temporary installation barriers, such as temporary chain link fencing, along with temporary gate units, such as a swinging fence portion, often mounted on wheels, that can be opened to allow pedestrians or vehicles to pass through. Temporary barrier systems typically also include modular barrier panels and ballast support means, such as weighted support bars or platforms. The ballast systems can either be relatively lightweight and easy to position or install, or can be extremely heavy and difficult to position and move. Temporary barrier systems that use relatively lightweight ballasts are suitable for erecting the temporary barrier system; however, they are often unstable against extreme weather conditions or against toppling by an intruder. In addition, in order to minimize the type of ballast, gate units are typically designed with stability first in mind because the opening and closing of a gate alters the tension placed on the temporary barrier system and thus may require additional ballast to remain secure. Thus, a gate system often must be set first, with the rest of the temporary barrier system installed around the fixed gate location, thus preventing operational flexibility during installation and use of the temporary barrier system.

The present disclosure relates to improved rapidly deployable temporary barrier systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some aspects, the techniques described herein relate to a temporary gate module for a temporary barrier system, the temporary gate module including: a temporary gate unit; and one or more ballast units configured to be fixedly coupled to the temporary gate unit, the one or more ballast units including a base portion having a mass that stabilizes the temporary gate unit when secured thereto, at least one lifting feature defined along a bottom of the base portion, a plurality of guide posts disposed along a top of the base portion, a mounting bracket configured to detachably couple the base portion to the temporary gate unit, the mounting bracket including a base coupling portion configured to adjustably receive the plurality of guide posts, and a gate coupling portion configured to fixedly couple the mounting bracket to the temporary gate unit.

In some aspects, the techniques described herein relate to a temporary gate module for a temporary barrier system, the temporary gate module including a temporary gate unit; and one or more ballast units configured to be fixedly coupled to the temporary gate unit, the one or more ballast units including a molded block portion having a mass that stabilizes the temporary gate unit when secured thereto, and a plurality of guide posts extending laterally from the molded block portion and configured to be adjustably coupled to a block coupling portion of the temporary gate unit in at least one of a vertical and horizontal position.

In some aspects, the techniques described herein relate to a temporary barrier system including one or more of the temporary gate modules, one or more temporary ballast assemblies, one or more temporary barrier posts configured to couple to the one or more temporary ballast assemblies, one or more temporary barrier panels configured to couple to the one or more temporary barrier posts, and one or more clips configured to couple the one or more temporary barrier panels to the one or more temporary barrier posts.

In some aspects, the techniques described herein relate to a temporary gate module for a temporary barrier system, the temporary gate module including one or more ballast units; and a gate unit configured to be fixedly coupled to the one or more ballast units.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an environmental view of a temporary barrier system with a temporary gate module according to an example of the present disclosure;

FIG. 2 is a front perspective view of a temporary gate module according to an example of the present disclosure;

FIG. 3 is a view of a ballast unit of the temporary gate module of FIG. 2;

FIG. 4A is a schematic of a mounting bracket coupled in a neutral orientation to a ballast unit of a temporary gate module according to an example of the present disclosure;

FIG. 4B is a schematic of a comparative mounting bracket coupled in a neutral orientation to a ballast unit of a temporary gate module according to an example of the present disclosure;

FIG. 4C is a schematic of a mounting bracket coupled in a first-raised orientation to a ballast unit of a temporary gate module according to an example of the present disclosure;

FIG. 4D is a schematic of a comparative mounting bracket coupled in a first-raised orientation to a ballast unit of a temporary gate module according to an example of the present disclosure;

FIG. 4E is a schematic of a mounting bracket coupled in a second-raised orientation to a ballast unit of a temporary gate module according to an example of the present disclosure;

FIG. 4F is a schematic of a comparative mounting bracket coupled in a second-raised orientation to a ballast unit of a temporary gate module according to an example of the present disclosure;

FIG. 5 is a view of a ballast unit of the temporary gate module according to an example of the present disclosure;

FIG. 6 is a view of a first mounting bracket of the ballast unit of FIG. 5;

FIG. 7 is an environmental view of a temporary barrier system with a temporary gate module according to an example of the present disclosure;

FIG. 8 is a front perspective view of a temporary gate module according to an example of the present disclosure;

FIG. 9 is a view of a ballast unit of the temporary gate module of FIG. 8;

FIG. 10 is a view of a block coupling portion of the temporary gate module of FIG. 8;

FIG. 11 is an environmental view of a temporary barrier system according to an example of the present disclosure;

FIG. 12 is a view of a temporary ballast assembly coupled to a temporary barrier panel of the temporary barrier system of FIG. 11, according to an example of the present disclosure;

FIG. 13 is a front perspective view of a temporary ballast assembly according to an example of the present disclosure;

FIG. 14 is a front bottom perspective view of the temporary ballast assembly of FIG. 13;

FIG. 15 is a rear perspective view of the temporary ballast assembly of FIG. 13;

FIG. 16 is a top view of the temporary ballast assembly of FIG. 13;

FIG. 17 is a bottom view of the temporary ballast assembly of FIG. 13;

FIG. 18 is a front view of the temporary ballast assembly of FIG. 13;

FIG. 19 is a front cross-sectional view of the temporary ballast assembly of FIG. 13;

FIG. 20 is a rear view of the temporary ballast assembly of FIG. 13;

FIG. 21 is a first side view of the temporary ballast assembly of FIG. 13;

FIG. 22 is a first side cross-sectional view of the temporary ballast assembly of FIG. 13;

FIG. 23 is a second side view of the temporary ballast assembly of FIG. 13;

FIG. 24 is a perspective view of a clip according to an example of the present disclosure; and

FIG. 25 is a perspective view of a clip coupling a temporary barrier post to a temporary barrier panel according to an example of the present disclosure; and

FIG. 26-34 are photos showing various installations.

TABLE 1
Listing of Drawing Elements

100 temporary barrier system
100′ temporary barrier system
110 temporary barrier post
112 temporary barrier post
112′ temporary barrier post
120 temporary barrier panel
200 temporary gate module
202 temporary gate unit
204 ballast unit
206 base portion
206′ base portion
208 lifting feature
210 guide post
212 mounting bracket
212a′ first mounting bracket
212b′ second mounting bracket
213 flat mounting bracket
214 base coupling portion
214a′ first base coupling portion
214b′ second base coupling portion
216 gate coupling portion
217a′ first raised gate coupling portion
217b′ second raised post coupling
portion
218 post coupling portion
219a′ first coupling support member
219b′ second coupling support member
220 door
221′ transverse base
222 door frame
223′ transverse base
224 pedestrian gate post
224′ pedestrian gate post
226a′-d′ plurality of level
adjustment members
300 temporary barrier system
310 temporary barrier post
320 temporary barrier panel
400 temporary gate module
402 temporary gate unit
404 ballast unit
406 molded block portion
410 guide post
412 block coupling portion
413a first mounting slot
413b second mounting slot
413c third mounting slot
413d fourth mounting slot
420 vehicle gate
422 vehicle gate mounting post
424 fixed end
426 telescoping end
500 temporary ballast assembly
502 container body
504 ballast receptacle
506 first post-receiving receptacle
member
508 post mounting assembly
510 spacers
512 outer portion
514 container lifting assembly
516 ballast
518 side wall
518a first side wall
518b second side wall
518c third side wall
518d fourth side wall
520 floor
522 primary coupling tab
524 primary ground coupling points
526 inner portion
528 base
530 upper rim portion
532 second post-receiving receptacle
member
534 receptacle body
534a top open end
534b bottom closed end
536 fastener
538 third post-receiving receptacle
member
540 secondary coupling tab
542 secondary ground coupling point
600 clip
601 clip body
602 clip-to-post coupling points or
openings
604 clip-to-barrier panel coupling point
606 receiving volume

### DETAILED DESCRIPTION

The detailed description set forth below in connection with the appended drawings, where like numerals reference like elements, is intended as a description of various examples of the disclosed subject matter and is not intended to represent the only examples. Examples described in this disclosure are provided merely as examples or illustrations and should not necessarily be construed as preferred or advantageous over other Examples. The illustrative examples provided herein are not intended to be exhaustive or to limit the claimed subject matter to the precise forms disclosed.

To account for the above noted problems and more, gate units have been developed that can be used as free-standing entities or are installed as a connecting unit between adjacent segments of a barrier, thus providing some flexibility. However, these solutions typically fail to address the flexibility of deployment concerns, specifically when a gate location needs to be changed. These solutions also typically fail to provide support for fencing and gate units installed on uneven terrain. Moreover, typical temporary barrier systems are unable to be converted easily into permanent barrier systems, thus requiring an expensive removal and reinstallation process if the secure location becomes more permanent and permits for ground anchoring have been approved.

The present disclosure relates generally to an improved rapidly deployable temporary gate module for a temporary barrier system that provides quick deployment, improved stability against toppling, easy interchangeability with existing barrier segments for moving the location of a temporary gate module, and which can be installed along uneven terrain without requiring timely permitting processes. Further described herein is a temporary gate module configured for integration with a temporary barrier system. Using the systems and methods disclosed herein, secure, adaptable, temporary barrier systems can be installed at a location at a rapid speed. For instance, using the systems and methods disclosed herein, four installers can erect 1000 feet or more of a temporary barrier system per day of work, and the position of the temporary gate module can be changed without altering the position of the rest of the temporary barrier system.

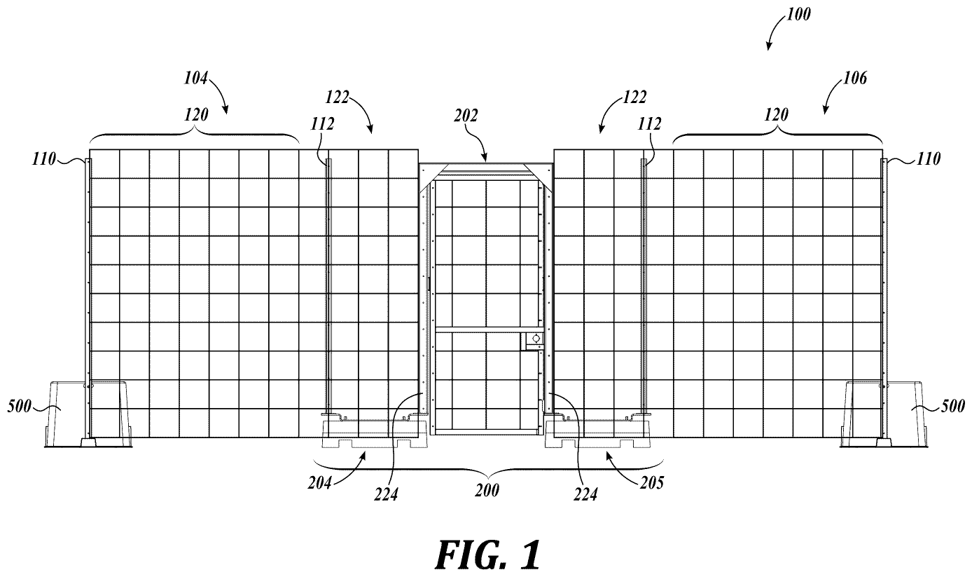

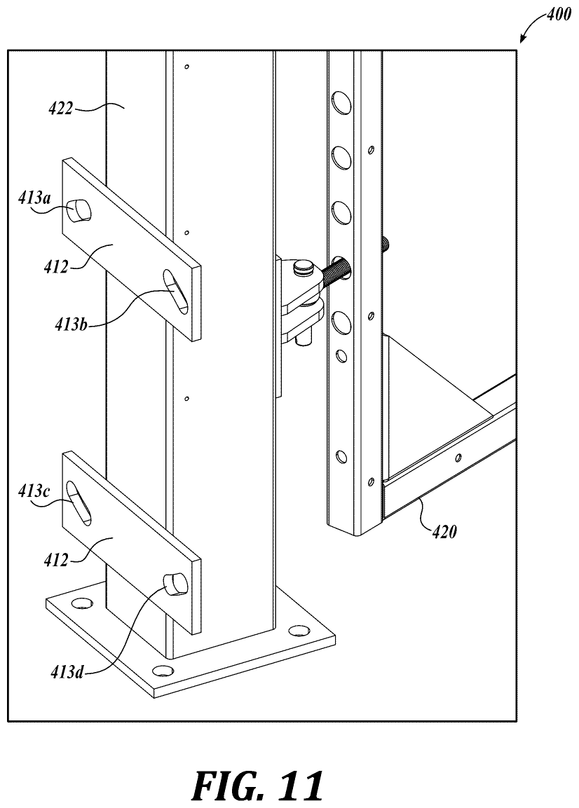

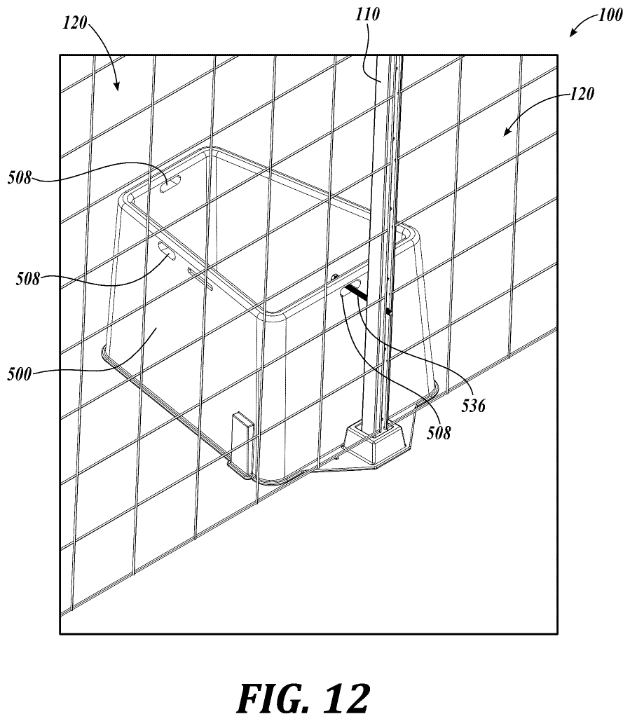

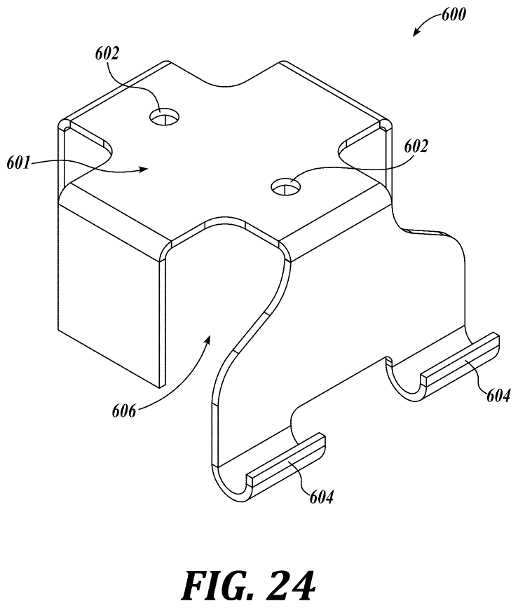

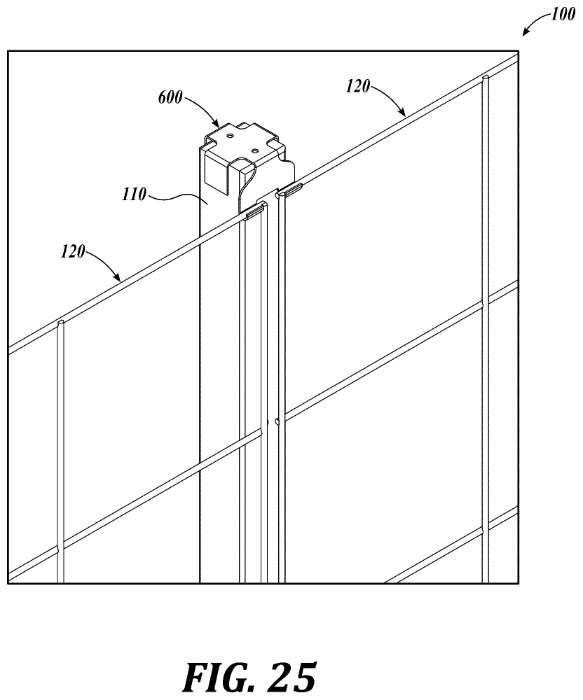

FIG. 1 is an environmental view of a temporary barrier system 100 that may be constructed with a temporary gate module 200. The temporary barrier system 100 includes a temporary gate module 200 disposed between first and second barrier panel assemblies 104 and 106. Each of the first and second barrier panel assemblies 104 and 106 include one or more temporary ballast assemblies 500 (as is best seen in FIG. 11 and FIG. 12), one or more temporary barrier posts 110 couplable to the one or more temporary ballast assemblies 500, and one or more temporary barrier panels 120 couplable to the one or more temporary barrier posts 110 (such as using one or more clips 600 described further herein below with respect to FIG. 24 and FIG. 25).

For ease of description, the temporary barrier system 100 will be described with respect to the one or more temporary ballast assemblies 500 installed in the same orientation, and with the temporary barrier panels 120 and temporary gate module 200 extending substantively along a line and across level ground, such that there is generally a 180-degree angle formed between adjacent temporary barrier panels 120. It should be appreciated, though, that the temporary barrier system 100 may be used with one or more temporary ballast assemblies 500 in any suitable orientation. Moreover, adjacent temporary barrier panels 120 and temporary gate modules 200 may be installed at any angle between about 0 degrees and 180 degrees. In that regard, the temporary barrier system 100 may be configured to substantively enclose an area that is substantively a triangle, a square, a rectangle, a pentagon, a hexagon, an octagon, a nonagon, a decagon, or any other polygon, regular or irregular. Moreover, temporary barrier system 100 may be configured to form a barrier line along substantively level ground, along a slope running perpendicular to the line of the barrier, along a slope running parallel to the line of the barrier, or any combination thereof.

While the temporary barrier system 100 is shown and described with respect to first and second barrier panel assemblies 104 and 106 and one temporary gate module 200, the temporary barrier system 100 can be constructed with any suitable number of component parts to achieve the desired temporary barrier size and structure, and with the desired number of temporary gate modules 200. Additionally, a temporary barrier system can instead or additionally be integrated with a temporary gate module 400 as will be described below.

Exemplary aspects of a temporary barrier post 110, which is configured for coupling a temporary ballast assembly 500 to a temporary barrier panel 120, will now be described in detail. The temporary barrier post 110 is generally configured to attach to each of the temporary barrier panels 120 at a plurality of positions to support adaptability of installation, while maintaining structural integrity and preventing intrusions, and while allowing for quick installation for rapid deployment needs.

Temporary barrier post 110 may have any suitable cross-section, such as a substantively round cross section, a substantively rectangular cross section, etc. The length of temporary barrier post 110 may be selected based on the desired temporary barrier system height, while the thickness may be selected, for instance, to optimize for cost efficiency, ease of installation, and structural integrity. In some examples, the temporary barrier post 110 may be formed from any suitable material for coupling a temporary ballast assembly 500 to a temporary barrier panel 120. In some examples, the temporary barrier post 110 may be formed from stainless steel, iron, galvanized iron, aluminum, steel, powder coated steel, polymer coated steel, or polymer.

Coupling of the temporary barrier post 110 to the temporary barrier panel 120 can be accomplished by any suitable means, such as by a plurality of threaded bolts, a plurality of clips, or a plurality of locking bolts. In the depicted example, a plurality of holes extend substantively transversely through the temporary barrier post 110 to receive fasteners therein. The fasteners may pass through the temporary barrier post 110 and the temporary barrier panel 120, as well as to the temporary ballast assembly 500, to enable coupling therebetween. In some examples, the fasteners may pass through the temporary barrier post 110 and a washer clip comprising a plurality of fingers configurable to grab and retain the temporary barrier panel 120.

Exemplary aspects of a temporary barrier panel 120, which is configured for separating areas, will now be described. Generally, the temporary barrier panel 120 may be any suitable configuration applicable for the intended use. In some examples, the temporary barrier panel 120 is designed with an anti-scale material and/or configuration. For instance, the temporary barrier panel 120 may include a chain link, a mesh, or a plurality of crossbars. The temporary barrier panel 120 may instead be defined by any suitable barrier material, such as a polymer material, a steel, an iron, a galvanized iron, a polymer coated metal, an aluminum, or a combination thereof.

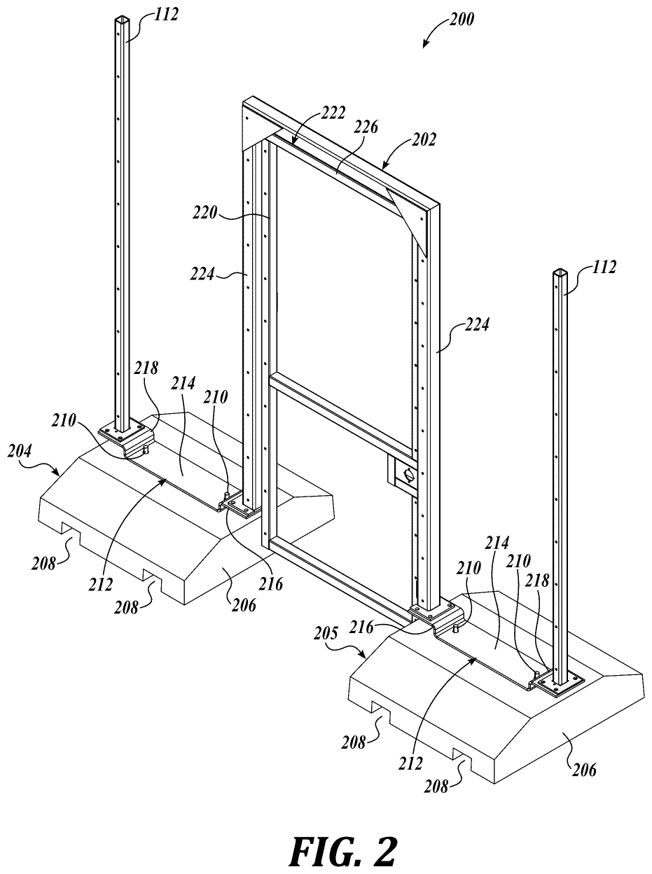

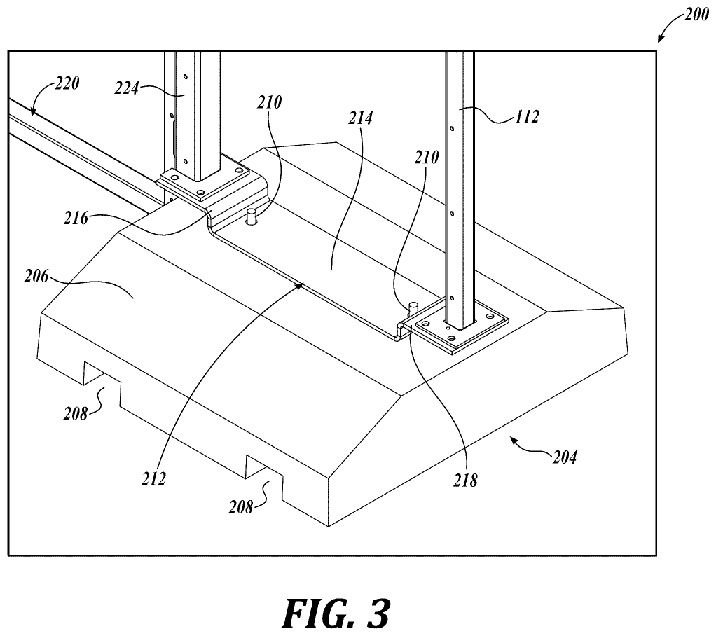

The temporary gate module 200 will next be described with reference to FIGS. 2-4. The temporary gate module 200 is generally configured to provide a secure access point through the temporary barrier system 100 for a pedestrian. At the same time, the temporary gate module 200 is generally configured to be flexibly, simply, and efficiently installed in a portion of temporary barrier system 100. In that regard, the temporary gate module 200 is generally configured to be interchangeable with a temporary barrier panel 120.

For instance, a temporary gate module 200 can be installed in a first location of the temporary barrier system 100 during initial construction of the temporary barrier system 100 for a first use scenario. When the first use scenario changes to a second use scenario, such that a different access point is more convenient or additional access points are required, temporary barrier panels 120 can be removed without altering the overall structure of the temporary barrier system 100 and be replaced with temporary gate modules 200. Similarly, when the first use scenario changes to a third use scenario, such that fewer access points may be desired or an original access point is no longer desired, previously installed temporary gate modules 200 can be removed without altering the overall structure of the temporary barrier system 100 and be replaced with temporary barrier panels 120.

In the illustrated example, the temporary gate module 200 has a length that is substantively identical to a length of one temporary barrier panel 120. Moreover, a height of the temporary gate module 200 may be substantially identical to a height of a temporary barrier panel 120. In this manner, a temporary gate module 200 may be interchanged with a temporary barrier panel 120 as needed without significant changes to the temporary barrier system 100. In other words, the temporary gate module 200 may substitute for one temporary barrier panel 120. As will be apparent, such interchangeability can reduce inefficiencies and improve access security based on the evolving needs of persons entering and exiting the secured perimeter.

In the depicted example, the temporary gate module 200 generally includes a temporary gate unit 202 and first and second ballast units 204 and 205. The first and second ballast units 204 and 205 are each configured to be fixedly coupled to and provide foundational support for the temporary gate unit 202. The first and second ballast units 204 and 205 are also each configured to be fixedly coupled to and provide foundational support for a temporary barrier post 112 of a gate assembly and a temporary barrier panel 122 (e.g., a temporary barrier panel that is smaller in length than a temporary barrier panel 120 to fill a barrier gap on each side of the temporary gate unit 202). In that regard, the first and second ballast units 204 and 205 enable the temporary gate unit 202 to be secured to the temporary barrier panels 120 and 122 of the temporary barrier system 100.

Additionally, a door 220 of the temporary gate module 200 and the gate assembly temporary barrier panels 122 may be designed with an anti-scale material and/or a configuration like the temporary barrier panel 120. In that regard, the door 220 and gate assembly temporary barrier panel 122 of the temporary gate module 200 may include a chain link, a mesh, or a plurality of crossbars. In this manner, the temporary gate module 200 can provide an uninterrupted barrier for the temporary barrier system 100 while facilitating secure entry therethrough.

The first and second ballast units 204 and 205 will be first described in detail. The first and second ballast units 204 and 205 are substantially identical; and therefore, only the first ballast unit 204 will be described in detail. The first ballast unit 204 includes a base portion 206 having a mass that stabilizes the temporary gate unit 202 when secured thereto, at least one lifting feature 208 defined along a bottom of the base portion 206, a plurality of guide posts 210 extending from a top of the base portion 206, and a mounting bracket 212 configured to detachably couple the base portion 206 to the temporary gate unit 202.

The dimensions and weight of the base portion 206 are selected so as to provide adequate ballast to provide stability to the temporary gate unit 202. In some examples, the base portion 206 defines a footprint area of about 4 ft², about 5 ft², about 6 ft² about 7 ft², about 8 ft², or about 9 ft². In some examples, the footprint area of base portion 206 is selected so as to provide a topple resistance metric defined by the resistance of the temporary gate module 200 to toppling. Toppling may occur when a force is pressed against the temporary gate module 200, such as by one or more potential intruders pressing against the temporary gate unit 202. In some examples, the topple resistance metric may be greater than 100 pounds of force, greater than 200 pounds of force, greater than 300 pounds of force, greater than 400 pounds of force, greater than 500 pounds of force, greater than 600 pounds of force, greater than 700 pounds of force, greater than 800 pounds of force, greater than 900 pounds of force, or greater than 1000 pounds of force. In some examples, the topple resistance metric may be suitable to resist wind speeds of up to 80 miles per hour, up to 90 miles per hour, up to 100 miles per hour, up to 110 miles per hour, and up to 120 miles per hour.

Additionally, topple resistance can be improved by increasing the weight of the base portion 206 relative to the temporary gate unit 202. In some examples, the weight ratio of the base portion 206 to the temporary gate unit 202 are in the range of about 5:1 to about 15:1, about 6:1 to about 14:1, about 7:1 to about 13:1, about 8:1 to about 12:1, about 9:1 to about 11:1, or about 10:1. As such, the base portion 206 may be formed from any suitable material for achieving such a topple resistance, including stainless steel, iron, galvanized iron, aluminum, poured concrete, or reinforced concrete.

At the bottom of the base portion 206 there is at least one lifting feature 208. The lifting feature 208 provides a means for conveniently moving the ballast unit 204. In the illustrated example, the lifting feature 208 includes a pair of slots defined along a bottom of the base portion 206, wherein said pair of slots are configured to accept a pair of forklift forks. It should be appreciated that lifting feature 208 may take other forms, such as a plurality of pairs of sleeves substantially through the middle of the ballast unit 204 configured to accept a pair of forklift forks, or a plurality of lifting anchor points configured to be lifted, such as by winch attached to a chain.

Protruding from the top of the base portion 206 are a plurality of guide posts 210. The guide posts 210 provide convenient coupling points between the base portion 206 and the mounting bracket 212. In the illustrated example, the guide posts 210 are integrally secured in the body of the base portion 206, such as by a molding process. It should be understood, however, that guide posts 210 may also be removably coupled to the base portion 206, such as by coupling to the base portion 206 via threaded holes.

The guide posts 210 are designed to provide two or more connection points for coupling the mounting bracket 212 to the base portion 206. For example, the guide posts 210 may be defined by a threaded rod embedded directly in the base portion 206. In such an example, the mounting bracket 212 may include correspondingly sized holes configured to receive the guide posts 210. After passing the guide posts 210 through the holes in the mounting bracket 212, threaded nuts may be secured to ends of the threaded guide posts 210.

The guide posts 210 may be configured to withstand significant shear forces, such as shear forces of 2000 pounds or greater. In that regard, the guide posts 210 may be formed from a material with a suitable gauge such that they are also configured to resist bending when pressure is applied. In this way, the guide posts 210 are robust against both damage caused by pressure applied to the temporary gate unit 202 when the temporary gate unit 202 is coupled to the ballast unit 204, but also substantially resist damage caused during moving and storage of the ballast units 204.

The number of guide posts 210 installed in the ballast unit 204 may be 2 guide posts, 3 guide posts, 4 guide posts, 5 guide posts, 6 guide posts, or more. Additional guide posts 210 may be desirable in some examples to increase the resistance of the guide posts 210 to bending or other damage from force being applied to the guide posts 210. The guide posts 210 may be formed from any suitable material, including stainless steel and galvanized iron.

The mounting bracket 212, which provides an interface for coupling the base portion 206 to a variety of additional components of the temporary barrier system 100, including the temporary gate unit 202 and the first and second barrier panel assemblies 104 and 106, will now be described. While the guide posts 210 provide an anchor point for the first ballast unit 204, the mounting bracket 212 provides an adaptable interface for coupling various components to the first ballast unit 204.

For example, in the illustrated example of FIGS. 2-4, the mounting bracket 212 includes a base coupling portion 214 configured to adjustably receive the plurality of guide posts 210 and a gate coupling portion 216 configured to fixedly couple the mounting bracket 212 to a pedestrian gate post 224 of the temporary gate unit 202. In some examples, the mounting bracket 212 may also include a post coupling portion 218, which is configured to fixedly couple the mounting bracket 212 to the temporary barrier post 112 of the gate assembly temporary barrier panel 122. Thus, mounting bracket 212 may serve as a coupling interface between the base portion 206, the temporary gate unit 202, and the gate assembly temporary barrier panel 122.

As noted above, the gate coupling portion 216 is a substantially flat, planar structure. In that regard, the pedestrian gate post 224 may terminate in or otherwise be coupled to a planar mounting bracket or the like. The planar mounting bracket of each pedestrian gate post 224 may be secured to the corresponding gate coupling portion 216 in a suitable manner, such as by passing one or more bolts therethrough and securing a nut on the end of each bolt.

Similarly, the post coupling portion 218 is a substantially flat, planar structure. In that regard, the temporary barrier post 112 may terminate in or otherwise be coupled to a planar mounting bracket or the like. The planar mounting bracket of a temporary barrier post 112 may be secured to the corresponding post coupling portion 218 in a suitable manner, such as by passing one or more bolts therethrough and securing a nut on the end of each bolt.

Due to the difference in mounting position of the temporary barrier post 112 and the temporary barrier post 110, a height of the temporary barrier post 110 may be smaller than a height of the temporary barrier post 110 in order to maintain a constant height throughout temporary barrier system 100.

In that regard, a plurality of mounting holes may be defined in each of the base coupling portion 214, the gate coupling portion 216, and the post coupling portion 218 of the mounting bracket 212. For example, a plurality of holes may be defined in the base coupling portion 214 that are configured to align with the guide posts 210, as described above. Once the base coupling portion 214 has accepted the guide posts 210, nuts may be used to secure the base coupling portion 214 to the guide posts 210. Spacers may also be inserted between the top of the base portion 206 and the bottom of the mounting bracket 212, as described further herein below.

Similarly, a plurality of holes may be defined in each of the gate coupling portions 216 and a base of the pedestrian gate post 224. The plurality of holes in the gate coupling portion 216 of each mounting bracket 212 are alignable with the plurality of holes in the base of the pedestrian gate post 224. Bolts may be inserted therethrough and secured within the gate coupling portions 216 and corresponding bases of the pedestrian gate post 224 by a plurality of nuts. Finally, a plurality of holes may be defined in the post coupling portion 218 of each mounting bracket 212 and a base of the temporary barrier posts 112, where the plurality of holes are alignable. Bolts may be inserted therethrough and secured by a plurality of nuts.

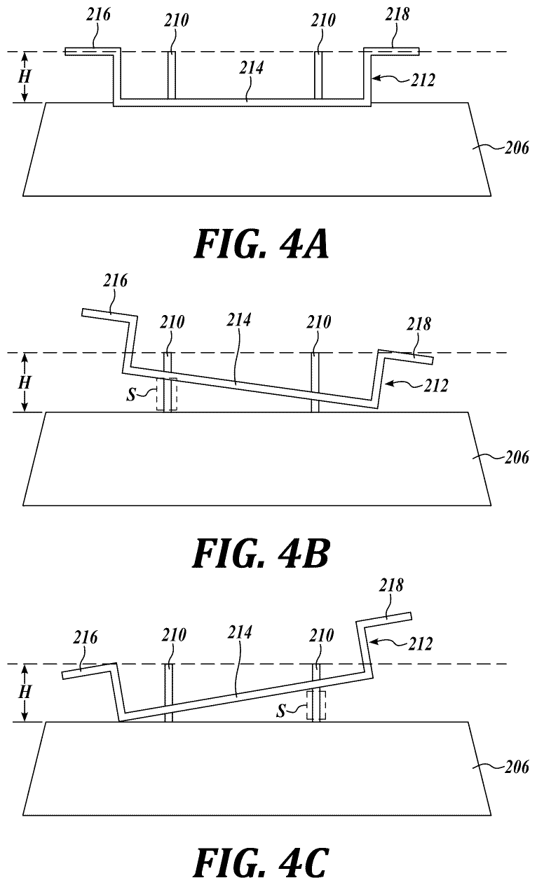

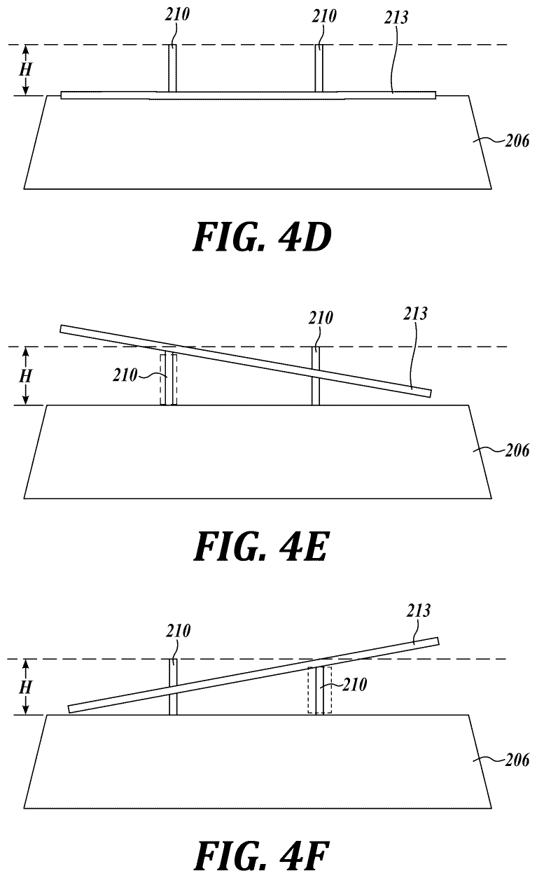

In the illustrated examples, the base coupling portion 214 of each mounting bracket 212 defines a first plane, while the gate coupling portion 216 and post coupling portion 218 of each mounting bracket 212 together define a second plane, where the first plane is substantially parallel to and offset from the second plane. In this manner, when the mounting bracket 212 is coupled to the base portion 206 in a first mounting configuration (such as that depicted in FIG. 4A), the base coupling portion 214 may lie substantively flat against an upper surface of the base portion 206. At the same time, the gate coupling portion 216 and post coupling portion 218 are offset vertically relative to the upper surface of the base portion 206.

With the gate coupling portion 216 and post coupling portion 218 offset vertically relative to the upper surface of the base portion 206, a nut may be easily secured to the end of a bolt passing through the gate coupling portion 216 and post coupling portion 218 and the base of the pedestrian gate post 224 and the temporary barrier post 112, respectively. The access space defined by the gate coupling portion 216 and post coupling portion 218 advantageously allows for easy installation and/or removal of the temporary gate unit 202 and the temporary barrier post 112. Specifically, the mounting bracket 212 provides access to both the insertion of a bolt and engagement with a nut to attach/detach the pedestrian gate post 224 and temporary barrier post 112 from the mounting bracket 212.

Such a first mounting configuration is suitable to support installation of at least a portion of a temporary barrier system 100 along substantively level ground. The mounting bracket 212 may also be used in other mounting configurations to accommodate variation in ground slope. When the temporary gate module 200 is installed on a sloped ground surface, one end of the mounting bracket 212, including the gate coupling portion 216 end or the post coupling portion 218 end, can be fixed to the base portion 206 in a manner that is vertically offset from the other end.

If such a configuration is used to accommodate variation in ground slope, as shown in the schematic views of FIGS. 4A-4C, spacers S may be inserted between the top surface of the base portion 206 and the bottom surface of the mounting bracket 212, such as around at least one of the guide posts 210. When spacers are inserted in this manner, one side of the mounting bracket 212 may be attached at a different positional height than a second side (as depicted best in FIG. 4B and FIG. 4C). In such a scenario, an additional advantage of a mounting bracket 212 defined in two planes is that a more significant height differential between the gate coupling portion 216 end and the post coupling portion 218 end can be achieved for the same guide post height than would be possible with a substantively flat bracket, such as flat mounting bracket 213 schematically depicted in FIGS. 4D, 4E, and 4F.

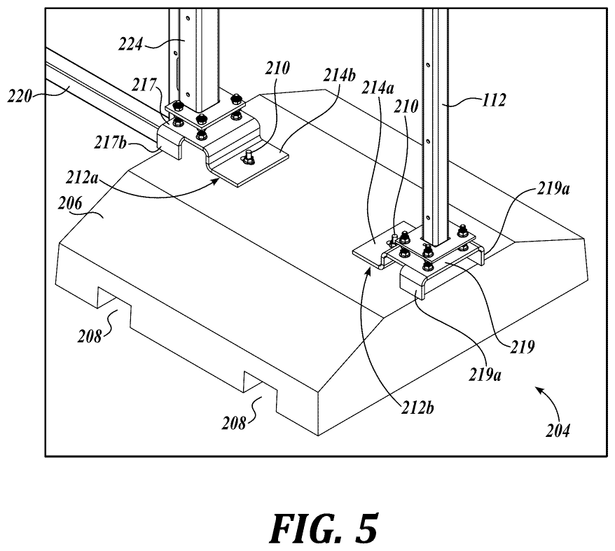

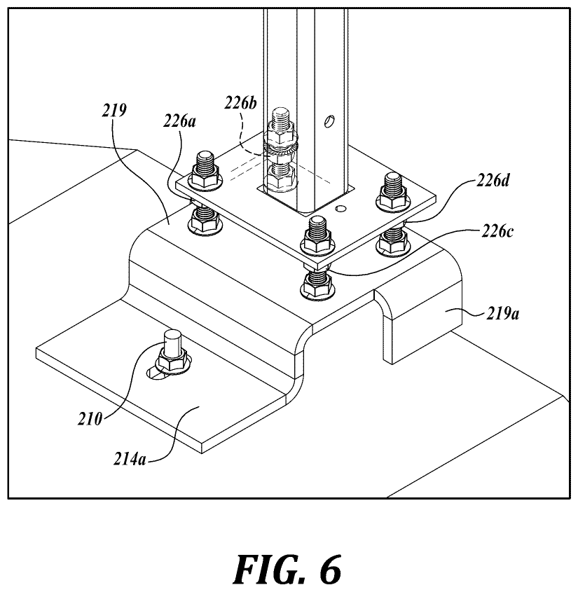

Another example of a temporary barrier system 100′ is illustrated in FIGS. 5-6. In general, the temporary barrier system 100′ is substantially identical to the temporary barrier system 100 except for the differences described herein. In that regard, like reference numerals are used for like parts except with a prime designation.

The temporary barrier system 100′ includes a first mounting bracket 212a′ and a second mounting bracket 212b′, each configured to be coupled to the base portion 206′ and to the pedestrian gate post 224′ and temporary barrier post 112′, respectively. Generally, the first and second mounting brackets 212a′ and 212b′ are configured to support adjustability of the vertical and/or horizontal position of the pedestrian gate post 224′ and temporary barrier post 112′, respectively. In that regard, an advantage of this configuration including a first and second mounting bracket 212a′ and 212b′, such as compared to the temporary barrier system 100 having a single mounting bracket 212, is that each mounting bracket can be individually configured to accommodate changes in terrain, as described further below. Moreover, such a configuration helps support targeted maintenance and adaptability of the temporary barrier system 100′ by enabling individual mounting bracket parts to be swapped out as desired by a user.

The first mounting bracket 212a′ includes a first base coupling portion 214a′, a first raised gate coupling portion 217a′ supported by a plurality of first coupling support members 219a′, and a first plurality of level adjustment members 226a′,b′,c′,d′. Similarly, the second mounting bracket 212b′ includes a second base coupling portion 214b′, a second raised post coupling portion 217b′ supported by a plurality of second coupling support members 219b′, and a second plurality of level adjustment members 226a′,b′, c′,d′.

In that regard, the first mounting bracket 212a′ and the second mounting bracket 212b′ are identical except for that they are substantially mirrored in configuration when coupled to the base portion 206′. As such, only the first mounting bracket 212a′ will be described in detail. However, it should be understood that the first mounting bracket 212a′ and the second mounting bracket 212b′ may be different, such as to accommodate different connection assemblies and/or loads coupled to either the first or second mounting bracket 212a′ or 212b′.

In the illustrated example, the first coupling portion 214a′ of the first mounting bracket 212a′ defines a first plane and the first raised gate coupling portion 217′ defines a second plane substantially parallel to and offset from the first plane. In this manner, when the first mounting bracket 212a′ is coupled to the base portion 206′, the first base coupling portion 214a′ may lie substantively flat against an upper surface of the base portion 206′. At the same time, the first gate coupling portion 217a′ is offset vertically relative to the upper surface of the base portion 206′.

The first raised gate coupling portion 217a′ is a substantially flat, planar structure. The first raised gate coupling portion 217a′ is raised relative to the upper surface of the base portion 206′. An advantage of this configuration is that a user may be able to access any coupling members thereunder, such as the plurality of level adjustment members 226a′,b′, c′,d′.

As noted above, the first raised gate coupling portion 217a′ is supported by a plurality of first coupling support members 219a′. In one aspect, the plurality of first coupling support members 219a′ are configured to vertically space the first raised gate coupling portion 217a′ from the upper surface of the base portion 206′. In another aspect, the plurality of first coupling support members 219a′ are configured to define a structural connection and transition between the first raised gate coupling portion 217a′ and the first base coupling portion 214a′. At the same time, the first raised gate coupling portion 217a′ provides suitable structural support (e.g., resistance to compressive, bending, and shear loads) for the first raised gate coupling portion 217a′ and any post supported by the first raised gate coupling portion 217a′.

In the illustrated example, the first raised gate coupling portion 217a′ and the plurality of first coupling support members 219a′ are formed from a single piece of material. That single piece of material is bent so that the plurality of first coupling support members 219a′ extend substantially transversely from the first raised gate coupling portion 217a′ toward the base portion 206′. However, the plurality of first coupling support members 219a′ may instead be defined by a separate piece of material that is connected to the first raised gate coupling portion 217a′, such as by welding.

The first mounting bracket 212a′ is configured to be secured to the base portion 206′ and to a post in a suitable manner. To accommodate such coupling, a plurality of mounting holes may be defined in each of the first base coupling portion 214a′ and the first raised gate coupling portion 217a′.

For example, one or more holes may be defined in the first base coupling portion 214a′. The one or more holes of the first base coupling portion 214a′ may be alignable with a guide post 210′. In some examples, the one or more holes of the first base coupling portion 214a′ may be elongated in shape or otherwise joined together to accommodate any misalignment between the hole(s) and the guide post 210′. Once the hole(s) in the first base coupling portion 214a′ has accepted the guide post 210′, a nut may be secured on the guide post 210′ to secure the first base coupling portion 214a′ to the guide posts 210′. The second base coupling portion 214b′ may be coupled to the other guide post 210′ in a similar manner.

Similarly, a plurality of holes may be defined in the first raised gate coupling portion 217a′ that are substantially alignable with a plurality of holes in a transverse base 221′ of the pedestrian gate post 224′. The plurality of holes in the first raised gate coupling portion 217a′ of the first mounting bracket 212a′ may be adjustably alignable with the plurality of holes in the base 221′ of the pedestrian gate post 224′. The second raised post coupling portion 217b′ and the transverse base 223′ of a temporary barrier post 112′ may similarly include alignable holes.

In that regard, the pedestrian gate post 224′ may terminate in or otherwise be coupled to a planar mounting bracket or the like, such as the transverse base 221′. Similarly, the temporary barrier post 112′ may terminate in or otherwise be coupled to a planar mounting bracket or the like, such as the transverse base 223′. The transverse base of each of the pedestrian gate post 224′ and the temporary barrier post 112′ may be adjustably secured to the corresponding first raised gate coupling portion 217a′ and second raised post coupling portion 217b′, respectively, in a suitable manner, such as via the plurality of level adjustment members 226a′,b′,c′,d′.

A description of the plurality of level adjustment members, or first, second, third, and fourth level adjustment members 226a′,b′,c′,d′ and how they may be used to adjustably secure the second raised gate coupling portion 217b′ to the temporary barrier post 112′ will now be described with reference to FIG. 6.

In general, the first, second, third, and fourth level adjustment members 226a′,b′, c′,d′ are configured to allow for positional adjustments of the pedestrian gate post 224′ relative to the base portion 206′. For instance, each of the first, second, third, and fourth level adjustment members 226a′,b′,c′, d′ are independently adjustable. In a specific example, each of the height, pitch, and roll of the temporary barrier post 112′ or pedestrian gate post 224′ can be independently adjusted with the level adjustment members 226a′,b′, c′, d′. An advantage of this configuration is that the temporary gate module 200 can be seamlessly integrated into the temporary barrier system 100′, regardless of variations in the angle of the terrain over which it is installed.

For ease of description, only the first level adjustment member 226a′ depicted in FIG. 6 will now be described. However, it is to be understood that second, third, and fourth level adjustment members 226b′,c′,d′ may be configured and operated in a similar manner. Further, fewer or more than four level adjustment members may instead be used. Moreover, that level adjustment members 226a′,b′,c′, d′ securing the first raised gate coupling portion 217a′ to the pedestrian gate post 224′ may also be configured and operated in a similar manner.

The first level adjustment member 226a′ is generally configured as a long bolt that protrudes upwardly through the second raised post coupling portion 217b′ and the transverse base 223′ of the temporary barrier post 112′. The upwardly protruding threaded portion of the bolt supporting a nut-washer-nut stack that defines the vertical position of the transverse base 223′ relative to the second raised post coupling portion 217b′.

In the illustrated example, a bolt passes through aligned openings in the second raised post coupling portion 217b′ and the transverse base 223′ of the temporary barrier post 112′. A plurality of nuts (and corresponding washers) are secured on the bolt to secure the second raised post coupling portion 217b′ relative to the temporary barrier post 112′ in a substantially spaced, parallel relationship.

For instance, after a bolt passes through an opening in the second raised post coupling portion 217b′ with a head of the bolt abutting a bottom surface of the second raised post coupling portion 217b′, a first nut may be secured to the bolt against the upper surface of the second raised post coupling portion 217b′. In this manner, the bolt is secured within the second raised post coupling portion 217b′.

A second nut is securable on the bolt against the bottom surface of the transverse base 223′ of the temporary barrier post 112′. After the body of the bolt passes through a corresponding opening in the transverse base 223′ of the temporary barrier post 112′, a third nut may be secured on the bolt against the upper surface of the transverse base 223′. When the second and third nuts are tightened relative to one another, the transverse base 223′ of the temporary barrier post 112′ is fixedly secured relative to the bolt.

By loosening, repositioning, and tightening the nuts of the first level adjustment member 226a′, the vertical position of a portion of the transverse base 223′ of the temporary barrier post 112′ may be adjusted. In this manner, the height, pitch, and roll of the temporary barrier post 112′ (or the pedestrian gate post 224′) may be adjusted by adjusting the position of one or more of the nuts of each of the level adjustment members 226a′,b′, c′,d′.

While level adjustment members 226a′,b′,c′, d′ are described above as a bolt supporting a nut-washer-nut stack, it is to be understood that other configurations are within the scope of the present disclosure and are within the knowledge of one having skill in the art. For example, any number of level adjustment members may be used. Additionally, the bolts or threaded rods may be permanently coupled to the first raised gate coupling portion 217a′ and second raised post coupling portion 217b′.

Exemplary aspects of the temporary gate unit 202 will now be described in detail with respect to FIGS. 1 and 2. Temporary gate unit 202 provides access to a pedestrian through the temporary barrier system 100. Thus, the temporary gate unit 202 can include any suitable pedestrian gate system, such as a door, a turnstile, a revolving door, etc. In the illustrated example, temporary gate unit 202 includes a door frame 222 and a door 220.

The door frame 222 is couplable to at least one of the pedestrian gate posts 224 located on either side of the door frame 222 (see FIG. 2). A horizontal gate frame member may extend between the pedestrian gate posts 224 to provide structural support for the door frame 222.

The door frame 222 may include corner brackets defined or secured to upper corners of the frame, thus preventing the door 220 from opening in a particular direction. The temporary gate unit 202 may include suitable mounting hardware, such as a spring system or a pneumatic door closer assembly to facilitate connection between the door 220 and door frame 222 and the door opening/closing process. While a unidirectional temporary gate unit 202 is depicted, the temporary gate unit 202 may also include multiple access points, such as for controlling access in and out of the temporary barrier system 100. Additionally, more than one temporary gate module 200 may be positioned adjacent to one another to accommodate larger volumes of pedestrians, such as for security at an entertainment event (a concert, a fair, etc.).

The illustrated example depicts a door 220 nested inside the door frame 222 and extending along a height of the frame. The door frame 222 is offset vertically from the ground due to the height of the ballast unit base portion 206 and mounting bracket 212. In that regard, the door 220 extends at least somewhat vertically below the door frame 222. In this manner, a lower horizontal edge of the door is positioned to lie substantially against or slightly raised relative to a portion of the ground (i.e., little to no gap is defined between the door and the ground). As such, the door 220 can effectively serve as a secured barrier to entry or exit between adjacent first ballast unit 204 and second ballast unit 205.

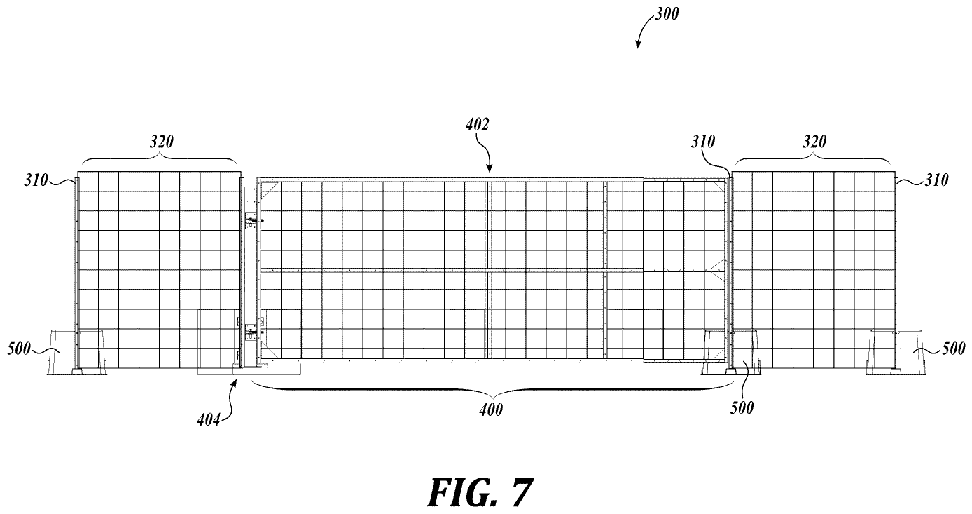

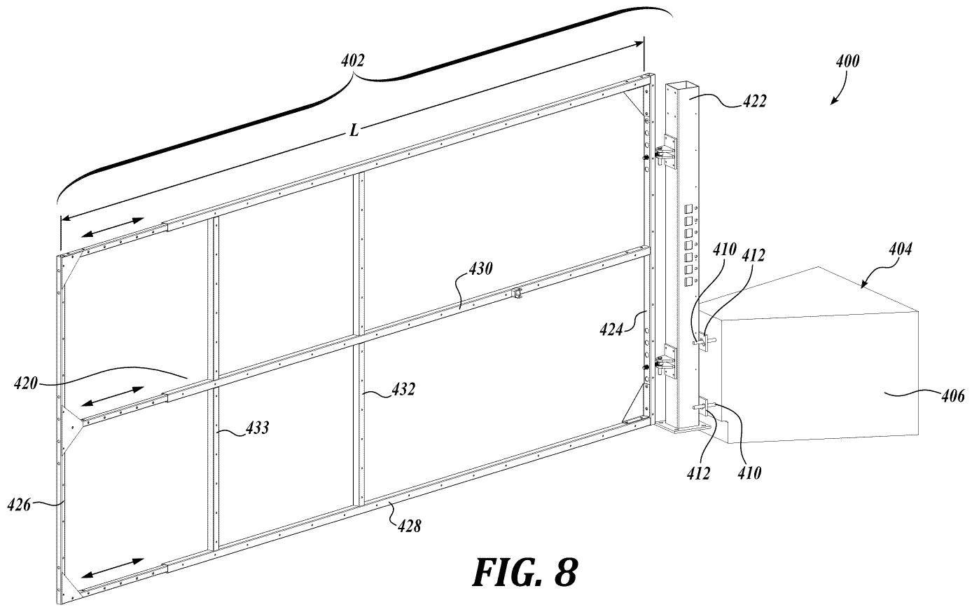

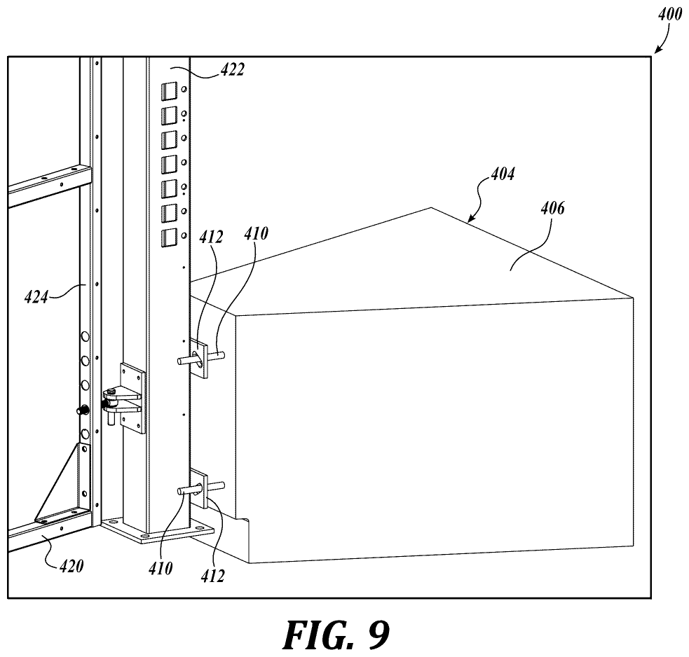

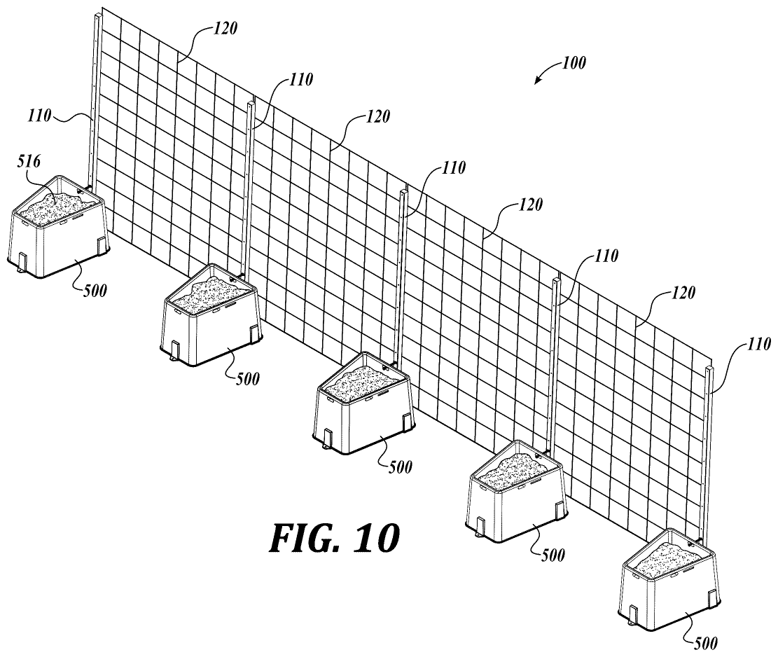

A second example of a temporary barrier system 300 will now be described with reference to FIGS. 7-10. The temporary barrier system 300 is substantially identical to the temporary barrier system 100, with the exception that the temporary gate module 400 differs from the temporary gate module 200 of the temporary barrier system 100. Thus, parts of the temporary barrier system 300 will be labeled with identical part numbers as the temporary barrier system 100 except in the '300 series (i.e., temporary barrier post 310 and temporary barrier panel 320). Moreover, only the temporary gate module 400 and how it impacts the function of the temporary barrier system 300 will be described in detail.

The temporary gate module 400 is generally configured to provide a secured access point through the temporary barrier system 300 for a vehicle (e.g., a car, a truck, a bicycle, a motorcycle, etc.). The temporary gate module 400 is also designed to be flexibly, simply, and efficiently installed in a portion of temporary barrier system 300 so as to be interchangeable with one or more temporary barrier panels 320.

For instance, a temporary gate module 400 can be installed in a first location of the temporary barrier system 300 during initial construction of the temporary barrier system 300 for a first use scenario. When the first use scenario changes to a second use scenario-such as if a new access point is more convenient, or when additional access points may be desired-temporary barrier panels 320 can be removed without altering the overall structure of the temporary barrier system 300 and replaced with temporary gate modules 400. Similarly, when the first use scenario changes to a third use scenario-such as if an existing access point is undesirable, or when fewer access points may be desired-previously installed temporary gate modules 400 can be removed without altering the overall structure of the temporary barrier system 300 and replaced with temporary barrier panels 320.

In the illustrated example, the temporary gate module 400 has a length that may be substantively identical to a cumulative length of two temporary barrier panels 320. Moreover, a height of the temporary gate module 400 may be substantially identical to a height of a temporary barrier panel 320. In this manner, a temporary gate module 400 may be interchanged with a temporary barrier panel 320 as needed without significant changes to the temporary barrier system 300. In that regard, the temporary gate module 400 may be interchanged with two temporary barrier panels 320. It should be understood, however, that the temporary gate module 400 may also have a length equivalent to one temporary barrier panel 320, or three or more temporary barrier panels 320. In some examples, the length of the temporary gate module 400 may be about 10 feet, about 12 feet, about 14 feet, about 16 feet, about 18 feet, or about 20 feet. In some examples, a barrier panel 320 may be cut to accommodate any suitable length for the temporary gate module 400.

As will be apparent, such interchangeability can reduce inefficiencies and improve access security based on the adapting needs of vehicles entering and exiting the secured perimeter.

In the depicted example, the temporary gate module 400 generally includes a temporary gate unit 402 and a ballast unit 404. The temporary gate unit 402 is configured to provide selective, secure access to an area. The ballast unit 404 is configured to be fixedly coupled to and provide foundational support for a vehicle gate mounting post 422 of the temporary gate unit 402. The ballast unit 404 is also configured to be fixedly coupled to and provide foundational support for a post of the temporary barrier panel 320. In that regard, the ballast unit 404 enables the temporary gate unit 402 to be modularly secured to the temporary barrier panels 320 of the temporary barrier system 300.

The ballast unit 404 will be first described in detail. The ballast unit 404 includes a weighted mass portion, or a molded block portion 406 and one or more post connection members, such as a plurality of guide posts 410. The molded block portion 406 is generally configured to provide a temporary, stabilizing anchor for the vehicle gate mounting post 422 of the temporary gate unit 402, and the plurality of guide posts 410 are generally configured to enable connection of the molded block portion 406 to the vehicle gate mounting post 422 of the temporary gate unit 402.

The molded block portion 406 has a mass that stabilizes the vehicle gate mounting post 422 of the temporary gate unit 402 when secured thereto. The dimensions and weight of the molded block portion 406 are selected so as to provide adequate ballast to provide stability to the vehicle gate mounting post 422 of the temporary gate unit 402. In some examples, the footprint area of molded block portion 406 is selected so as to substantially provide topple resistance defined by the load demand of the temporary gate unit 402. Toppling may occur when a force is applied against temporary gate unit 402, such as by one or more potential intruders pressing against the temporary gate unit.

In some examples, the topple resistance metric may be greater than 100 pounds of force, greater than 200 pounds of force, greater than 300 pounds of force, greater than 400 pounds of force, greater than 500 pounds of force, greater than 600 pounds of force, greater than 700 pounds of force, greater than 800 pounds of force, greater than 900 pounds of force, or greater than 1000 pounds of force. In some examples, the topple resistance metric may be suitable to resist wind speeds of up to 80 miles per hour, up to 90 miles per hour, up to 100 miles per hour, up to 110 miles per hour, and up to 120 miles per hour.

Additionally, the topple resistance can be improved by increasing the weight of the molded block portion 406 relative to the temporary gate unit 402. In some examples, the weight of the molded block portion 406 may be between 1000 pounds and about 5000 pounds, between about 2000 pounds and about 4000 pounds, or about 3000 pounds. In some examples, a weight ratio of the molded block portion 406 to the temporary gate unit 402 is between about 6:1 to about 14:1, between about 7:1 to about 13:1, between about 8:1 to about 12:1, between about 9:1 to about 11:1, or about 10:1.

The weight of the molded block portion 406 may be selected to optimize for cost, for topple resistance, for transportability, for ease of installation, or for some combination thereof. Accordingly, the molded block portion 406 may be formed from any suitable material for optimizing any of these outcomes and more. For example, the molded block portion 406 may be formed from poured concrete or reinforced concrete. Molded block portions 406 formed from reinforced concrete may include any suitable structural reinforcement, including reinforcement fibers, gravel, a metal mesh material, a polymeric mesh material, or metal bars.

The shape of the molded block portion 406 may be selected to optimize for topple resistance of the temporary gate module 400, compatibility with other barrier or gate components, etc. For instance, the molded block portion 406 may be of a generally truncated triangular cross-sectional shape. In that manner, a larger, widened end of the molded block portion 406 may be disposed distally from a vehicle gate mounting post 422 of the vehicle gate 420 to increase the stabilization of the vehicle gate mounting post 422. Further, the tapered portion of the molded block portion 406 may be located adjacent to the vehicle gate mounting post 422, thereby minimizing interference with through traffic, the gate, or the like.

The molded block portion 406 may have substantially flat surfaces. In this regard, the molded block portion 406 includes a substantively flat bottom portion configured to contact the ground, a substantially flat top surface opposite the bottom surface, first and second angled side surfaces defining the sides of the truncated triangular shape, and front and back surfaces defining the truncated top and the widen bottom of the truncated triangular shape.

To resist toppling of the molded block portion 406, a height of the molded block portion 406 is generally shorter than an overall length or width of the molded block portion 406 at its longest or widest point. In this way, the molded block portion 406 has a sufficiently low center of gravity so that the molded block portion 406 can resist toppling. Additionally, with the front side of the molded block portion 406 proximate the attachment point to the temporary gate unit 402 (through the vehicle gate mounting post 422), a higher percentage of the total weight distribution of molded block portion 406 is disposed a greater distance from the temporary gate unit 402, thus increasing the effective force against toppling of the temporary gate module 400.

An advantage of molded block portion 406 is that it provides a relatively low cost means for providing adequate ballast to temporary gate unit 402 in both open and closed gate configurations, while being readily transportable for the installation of a temporary barrier system.

As noted above, the ballast unit 404 includes a plurality of guide posts 410 configured to enable connection of the molded block portion 406 to components of the temporary gate unit 402, such as the vehicle gate mounting post 422. The plurality of guide posts 410 may protrude substantially transversely from the first side of the molded block portion 406.

In the illustrated example, the guide posts 410 are integrally secured in the body of the molded block portion 406, such as by a molding process. It should be understood, however, that guide posts 410 may also be removably coupled to the molded block portion 406, such as by coupling the guide posts 410 to the molded block portion 406 via threaded holes.

Each of the plurality of guide posts 410 may be defined by a metal rod or other suitable structure to withstand the loads of the temporary gate module 400. For instance, the guide posts 410 may be configured to withstand significant shear forces, such as shear forces of 2000 pounds or greater, 3000 pounds or greater, or 4000 pounds or greater. In that regard, the guide posts 410 may be formed from a material with a suitable strength and at a suitable gauge such that they are also configured to resist bending when pressure is applied. In this way, the guide posts 410 are robust against both damage caused by pressure applied to the temporary gate unit 402 when the temporary gate unit 402 is coupled to the ballast unit 404, but also resistant against damage caused during moving and storage of the ballast units 404. The guide posts 410 may be formed from any suitable material, including stainless steel, galvanized steel, and galvanized iron.

The number of guide posts 410 installed in the ballast unit 204 may be 2 guide posts, 3 guide posts, 4 guide posts, 5 guide posts, 6 guide posts, or more. Additional guide posts 410 may be desirable in some examples to increase the resistance of the guide posts 410 to bending or other damage from force being applied to the guide posts 410.

The guide posts 410 provide convenient coupling points between the molded block portion 406 and components of the temporary gate unit 402, such as the vehicle gate mounting post vehicle gate mounting post 422. In that regard, the guide posts 410 may be threaded, partially threaded, or non-threaded as needed to facilitate connection to the vehicle gate mounting post 422.

The guide posts 410 are also configured for adjustably coupling the vehicle gate mounting post 422 of the temporary gate unit 402 to the molded block portion 406 in at least one of a vertical and horizontal position. For example, the vehicle gate mounting post 422 may include a block coupling portion 412 configured for adjustably receiving the guide posts 410. Block coupling portion 412 provides an interface for adjustably coupling the molded block portion 406 to the temporary gate unit 402

Block coupling portion 412 may include any suitable structure for adjustable securing the plurality of guide posts 410 to the vehicle gate mounting post 422. In the illustrated example, block coupling portion 412 is configured as a plate transversely secured to and extending laterally from the body of vehicle gate mounting post 422. The block coupling portion 412 may be coupled to the vehicle gate mounting post 422 in any suitable manner, such as by welding of the block coupling portion 412 to the vehicle gate mounting post 422. However, other suitable means for coupling the guide posts 410 to the vehicle gate mounting post 422 are within the scope of the present disclosure, including a block coupling portion 412 formed directly in the vehicle gate mounting post 422. In other examples, the block coupling portion 412 and vehicle gate mounting post 422 may be formed from a single material, such as would be formed in a mold.

In the illustrated example, a body of each block coupling portion 412 may include a coupling slot 413 configured to adjustably receive a guide post 410. For instance, each slot 413 may extend substantially diagonally across a portion of a body of the block coupling portion 412 to receive a guide post 410 in one of a plurality of horizontal and vertical positions. After passing the guide posts 410 through the slots in the block coupling portion 412, threaded nuts may be secured to ends of the threaded guide posts 410 to secure the guide posts 410 in its position within the corresponding slot.

A plurality of mounting slots may be defined in each block coupling portion 412, such as first mounting slot 413a and second mounting slot 413b in a first block coupling portion 412, and a third mounting slot 413c and fourth mounting slot 413d in a second block coupling portion 412 (see FIG. 11). The plurality of guide post mounting slots provide a means of coupling the temporary gate unit 402 and the ballast unit 404 without requiring precise positioning such as, for example, what would be required if the coupling were accomplished via bored holes directly into the vehicle gate mounting post 422, as shown in the pedestrian gate post 224. In some examples, the plurality of guide post mounting slots 413a,b,c,d provide a means of aligning the vehicle gate mounting post 422 parallel to gravity. In some examples, the plurality of guide post mounting slots 413a,b,c,d provide a means of aligning the vehicle gate mounting post 422 to accommodate variations in the grade of the ground upon which the molded block portion 406 may be resting.

As illustrated, each of the pairs of mounting slots 413a/413b and 413c/413d are diagonally oriented in a mirrored configuration to define a vertical dimension and a horizontal dimension for the slot opening. In this way, each of the mounting slots 413a, 413b, 413c, and 413d may receive a guide post 410 at a number of vertical and horizontal positions relative to the vehicle gate mounting post 422. An advantage of this configuration is that the vehicle gate mounting post 422 may be oriented at a range of angles relative to vertical to account for differences in the angle of terrain. For example, if the terrain across which the temporary gate unit 402 is installed is not substantially level, a top portion of the vehicle gate mounting post 422 may need to be tilted relative to a vertical position with respect to the ground. By enabling coupling between the ballast unit 404 and the temporary gate unit 402 at a variety of vertical and horizontal configurations, the temporary gate unit 402 can be installed across a wide variety of terrains. Other slot designs and slot orientations may also be used to accommodate various installation terrains or configurations.

Additional exemplary aspects of the temporary gate unit 402, which is configured to provide selective, secure access to an area, will now be described in detail with respect to FIGS. 7-10. Temporary gate unit 402 includes a vehicle gate 420 and a vehicle gate mounting post 422. The vehicle gate 420 is configured to open and close to provide access to a vehicle through temporary barrier system 300. Thus, the temporary gate unit 402 can be defined as any suitable vehicle gate system, such as a sliding gate, a swinging gate, etc. The vehicle gate mounting post 422 provides a fulcrum point from which the vehicle gate 420 can open/close.

The vehicle gate mounting post 422 is fixedly coupled to the ballast unit 404, such as through the interface of the guide posts 410 and block coupling portions 412, as described above. In this manner, the vehicle gate mounting post 422 is fixedly positioned relative to the vehicle gate 420 to provide stabilizing support thereto.

A temporary barrier panel 320 may also be coupled to the vehicle mounting post 422 in a suitable manner. For example, a temporary barrier panel 320 may be directly coupled to the vehicle mounting post 422 by passing one or more bolts therethrough and securing a nut on the end of each bolt. As another example, one or more barrier mounting clips (not shown) may be used. In such an example, the one or more barrier mounting clips may be configured to fixedly couple to the vehicle mounting post 422 and to simultaneously removably receive an edge of the temporary barrier panel 320. Once temporary barrier panel 320 is received by the one or more barrier mounting clips, the temporary barrier panel 320 may be secured to the vehicle mounting post 422, such as by passing one or more bolts therethrough and securing a nut on the end of each bolt. In this manner, vehicle gate 420 is integrated into the temporary barrier system 300.

The vehicle gate mounting post 422 may terminate at its bottom end in a planar mounting bracket or the like (not labeled). The planar mounting bracket may be secured to the ground in a suitable manner to help prevent slippage, such as by passing one or more ground anchors therethrough and into a portion of the ground.

Vehicle gate mounting post 422 is designed to withstand strain placed against the vehicle gate mounting post 422 by supporting a large and heavy vehicle gate 420. This may be especially desirable when the vehicle gate 420 is in the illustrated free-standing configuration and there is no gate stabilizing unit on the free end of the vehicle gate 420. As such, vehicle gate mounting post 422 may have any suitable cross-sectional shape, such as a substantively round cross section, a substantively rectangular cross section, etc. The thickness of the vehicle gate mounting post 422 may be selected, for instance, to optimize for cost efficiency, ease of installation, and structural integrity. Thus, the vehicle gate mounting post 422 can be formed from any suitable material, including stainless steel, steel, iron, galvanized iron, aluminum, or polymer.

The length of vehicle gate mounting post 422 may be selected based on a desired temporary barrier system height. For example, vehicle gate mounting post 422 may have a length such that a top portion of the vehicle gate mounting post 422 is substantially co-planar with a top portion of a temporary barrier post 320 when both are installed in a temporary barrier system 300. In this manner, the overall height of the temporary barrier system 300 can be substantially consistent throughout the system.

In the illustrated example, temporary gate unit 402 includes a swinging vehicle gate 420. As such, the vehicle gate 420 can include a fixed end hingedly coupled to the vehicle mounting post 422, and a free end (such as telescoping end 426) that is substantially suspended above the ground. In this manner, the vehicle gate 420 can be opened/closed from an opening/closing means (not illustrated) coupled to the vehicle gate mounting post 422. In other examples, the free end of vehicle gate 420 may be coupled to a gate stabilizing unit (not illustrated), such as a wheeled caster. In such examples, the stability against toppling required from the ballast unit 404 may be less, and thus a smaller ballast unit 404 may be used when the free end has a gate stabilizing unit.

In some examples, the opening and closing of the vehicle gate 420 can be performed using a manual control system, such as by installation of a pneumatic tube assembly to assist with manual opening and closing by an operator of the vehicle gate 420. Similarly, the vehicle gate 420 can be configured to open/close using an automatic control system, such as via an automated pushers and pullers. An advantage of an automated control mechanism is that entry and exit from the temporary barrier system 300 are possible without requiring permanent security personnel. Furthermore, additional access control systems may be integrated into the temporary barrier system 300, such as the use of HID mobile access systems, biometric readers, smart-card-based credentials, or other secured access controls.

The illustrated example depicts a vehicle gate 420 with a gate frame 428, a horizontal gate support 430, a first vertical gate supports 432, and a second vertical gate support 433. The gate frame 428 defines a perimeter of the vehicle gate 420. As illustrated, the shape of the gate frame 428 is rectangular, however other suitable shapes and aspect ratios may be used. The interior of the gate frame 428 includes the horizontal gate support 430, connecting the fixed end 424 of vehicle gate 420 to the free end (such as telescoping end 426). An advantage of including horizontal gate support 430 is that it provides a horizontal spine to vehicle gate 420 to resist torsional forces that may be experienced during operation, thus improving the durability of vehicle gate 420.

At the same time, the interior of the gate frame 428 also includes a first vertical gate support 432 and a second vertical gate support 433. The first and second vertical gate supports 432 and 433 provide structural support for the gate frame 428 along the length of the vehicle gate 420. In this manner, the first and second vertical gate supports 432 and 433 are positioned along the length of the vehicle gate 420. While the illustrated example includes only a first and second vertical gate support and a single horizontal gate support, additional gate supports are within the scope of the present disclosure, including additional vertical gate supports, additional horizontal gate supports, and diagonal gate supports. The number of gate supports may be selected so as to optimize for structural stability of the vehicle gate 420 against the added weight of additional gate supports. An advantage of including vertical gate supports 432 and 433 is that it provides two or more vertical spines to vehicle gate 420 to resist compressing forces that may be experienced during operation, such as from attempts to scale vehicle gate 420, thus improving the durability of vehicle gate 420. Thus, vehicle gate 420 may be formed from high grade steel configured to withstand torsional forces, shear forces, and the like.

A face of the vehicle gate 420 may be substantially covered by the same barrier material as used in the temporary barrier panels 120 and 320. In that regard, the vehicle gate 420 of the temporary gate module 200 may include a chain link, a mesh, or a plurality of crossbars. In this manner, vehicle gate 420, when closed can provide similar anti-climb and anti-scale benefits as the remainder of temporary barrier system 300.

The length of vehicle gate 420 may be extended or contracted to fit a wider or narrower space. In this regard, vehicle gate 420 may include a telescoping end 426, where a distance between the fixed end 424 of the vehicle gate 420 and the telescoping end 426 may be increased or decreased. In such an example, the gate frame 428 and the horizontal gate support 430 may each include an inner portion and an outer portion. The outer portions may be fixedly coupled to the fixed end 424 of the vehicle gate 420, while the inner portions may be fixedly coupled to the telescoping end 426. Thus, the inner portion and the outer portion can be configured to slidably contact one another, such that the overall length of the vehicle gate can be adjusted.

When a desired vehicle gate 420 length is achieved, locking means (not illustrated) may be applied to the vehicle gate 420 to prevent further changes in the vehicle gate 420 length. In some examples, the length of the vehicle gate can be adjusted over a continuous range of sizes. In these examples, the inner and outer portions of the gate frame 428 and horizontal gate support 430 may be reversibly secured. For instance, the inner and outer portions may be secured by applying pressure from the outer portion to the inner portion, such as with a tension screw. In other examples, the length of the vehicle gate can be adjusted over a discrete number of possible lengths. For instance, each of the inner and outer portions of the gate frame 428 and horizontal gate support 430 may include a plurality of holes configured to receive a bolt. When a desired gate length is achieved, a bolt can be inserted through the plurality of holes in the inner and outer portions, with a back portion secured by a threaded nut.

An advantage of this telescoping configuration is the increased flexibility for gate configurations during installation. If a gap in the temporary barrier system 300 is slightly longer or narrower than one or more temporary barrier panels 320, the telescoping end 426 can be extended or contracted relative to the fixed end 424, thus allowing the vehicle gate 420 to snugly integrate into the temporary barrier system 300. For example, a gate length of the vehicle gate 420 may be extended from a first gate length to a second gate length by extending the telescoping end 426 relative to the fixed end 424.

An additional advantage of such an orientation is flexibility to position the vehicle gate 420 across an existing road segment that may have a different width than the length of one or more temporary barrier panels 320. In this regard, the vehicle gate 420 can be extended or contracted to substantially span an existing segment of road. In such configurations, the vehicle gate 420 may, when closed, form part of a single barrier line of the temporary barrier system 300. Alternatively, the vehicle gate 420 may, when closed, span a gap between two substantially parallel barrier segments of a temporary barrier system 300.

In some examples, two vehicle gates 420 may be installed adjacent to one another, thus providing a gate with two openings. In such a configuration, both vehicle gates 420 may open toward the same direction (e.g., a vehicle gate 420 on a left side opens clockwise and a vehicle gate 420 on a right side opens counterclockwise) so as to provide access to large vehicles. In other configurations, each of the two vehicle gates 420 may open toward opposite directions, thus permitting control of in-bound and out-bound traffic.

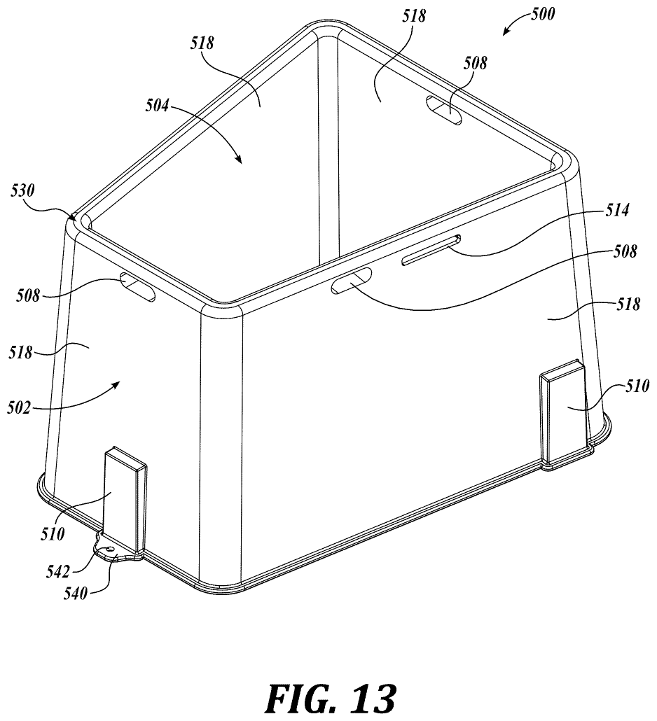

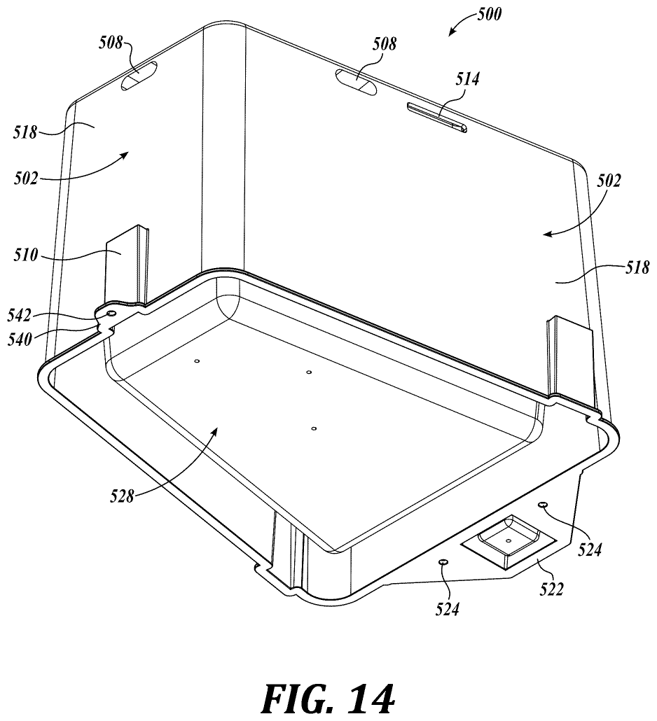

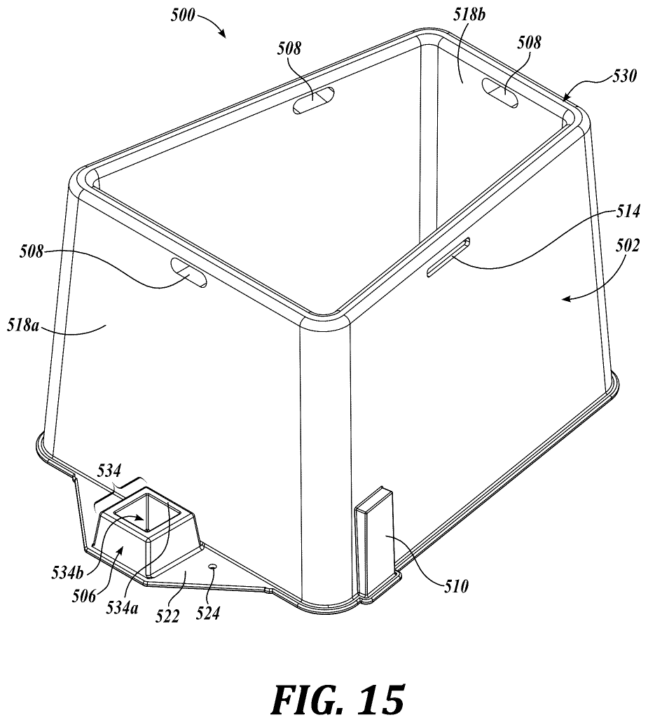

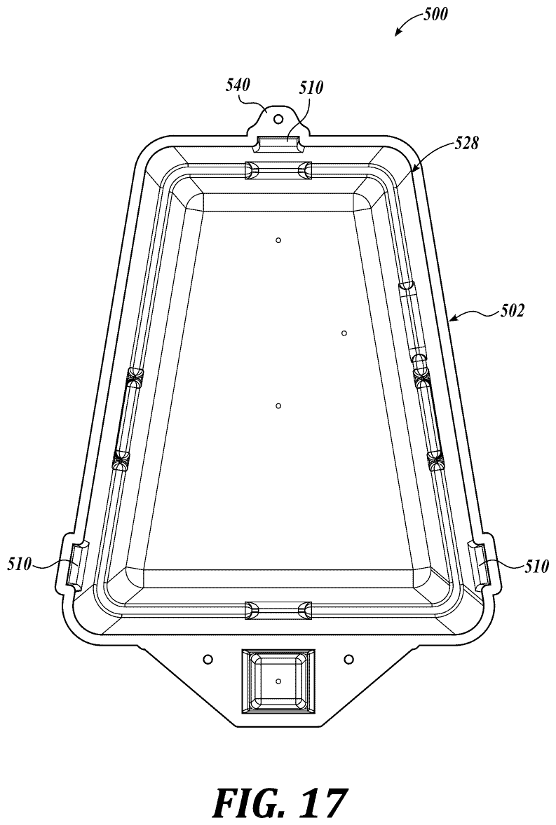

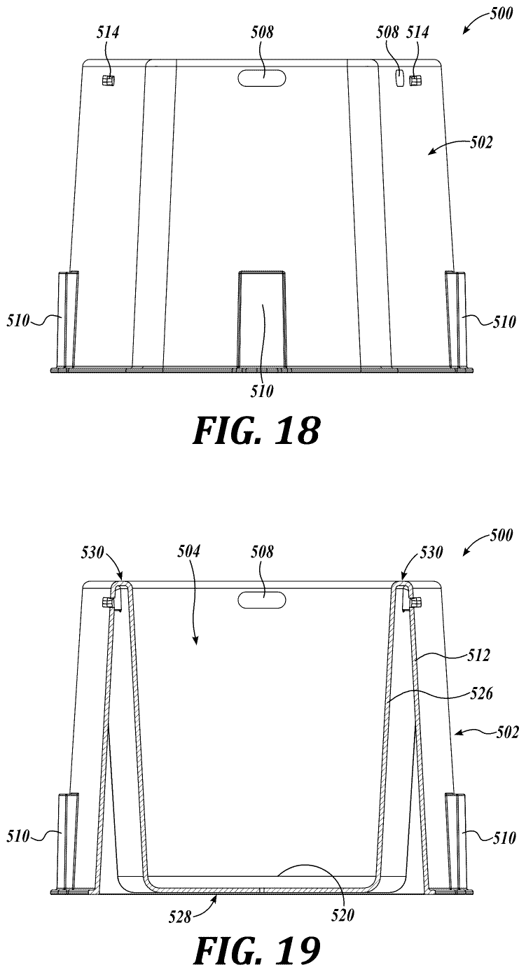

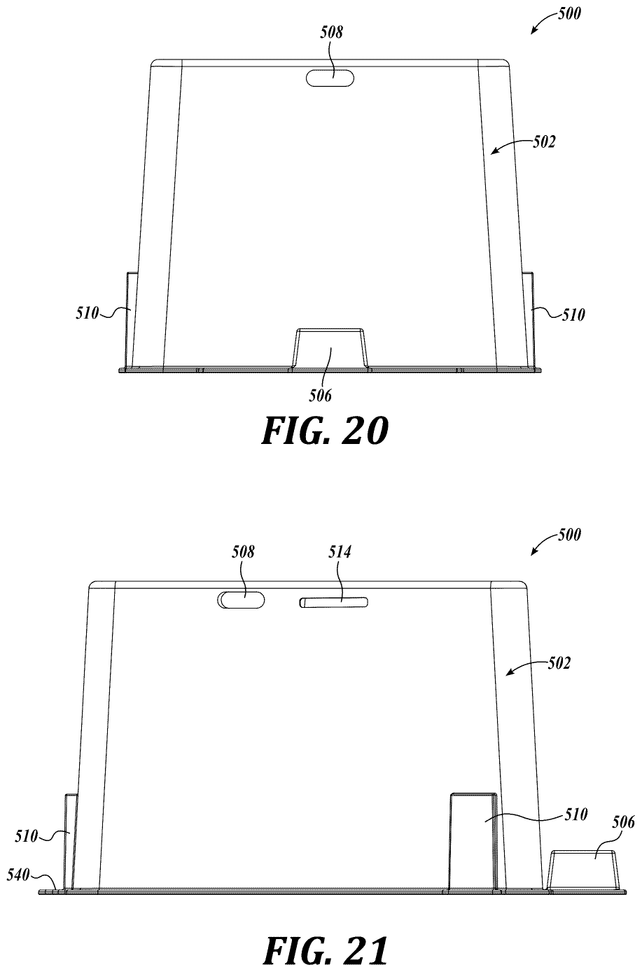

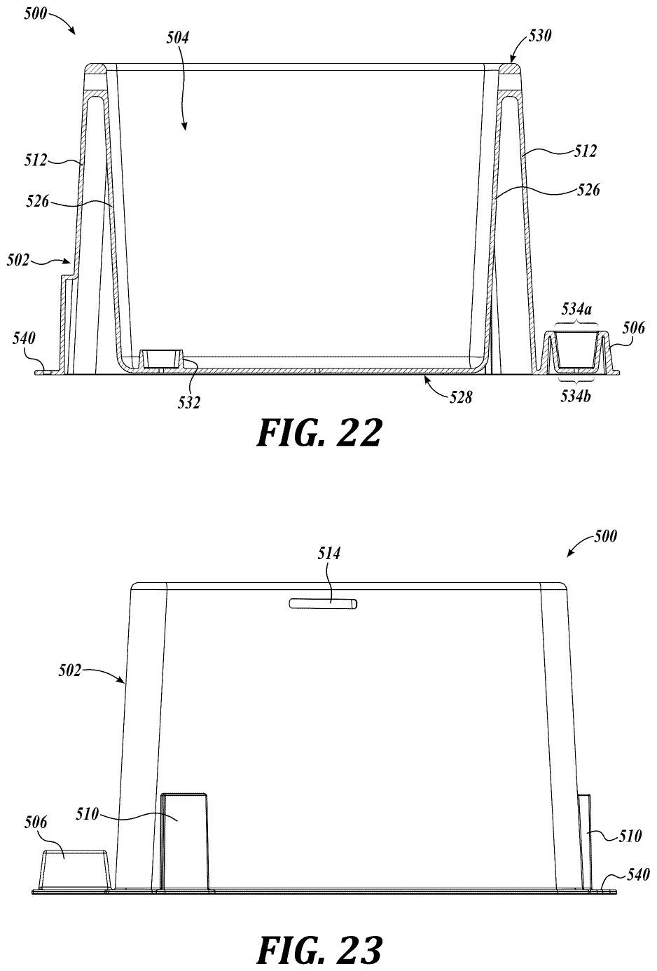

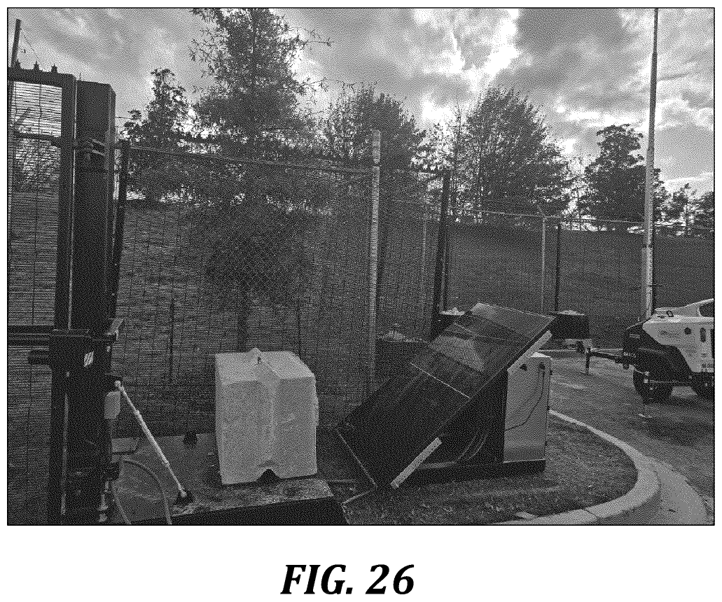

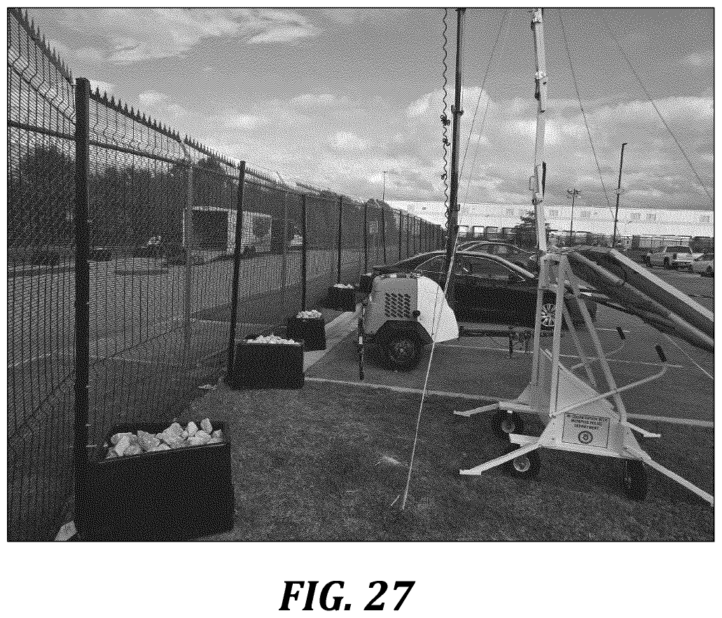

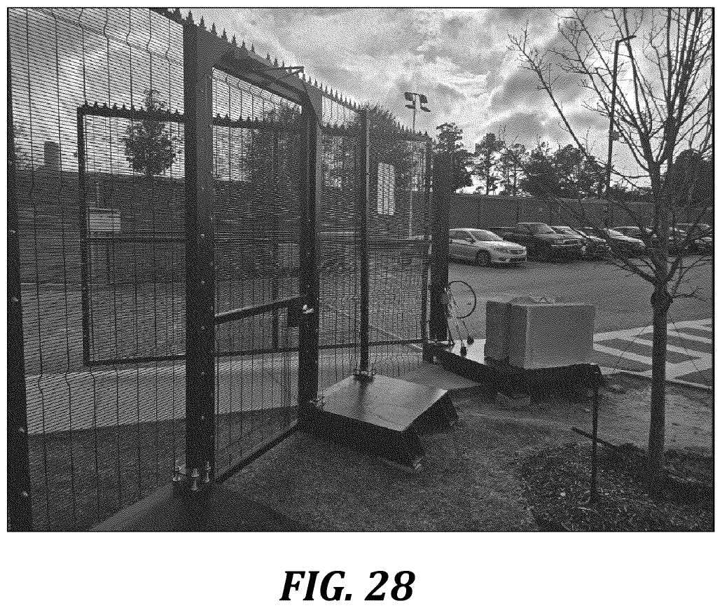

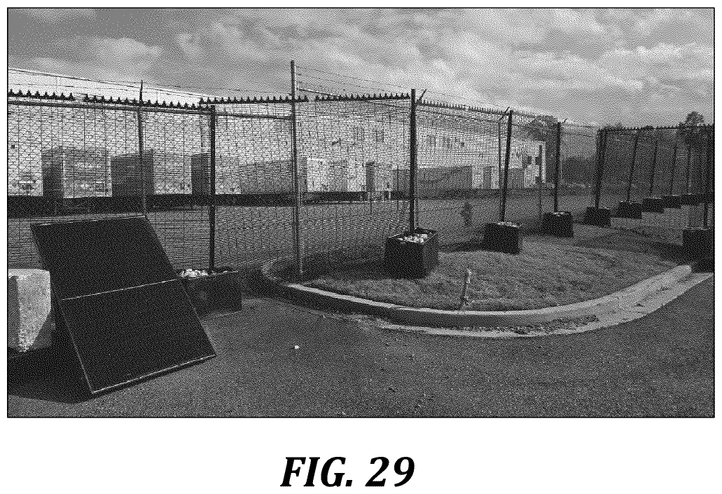

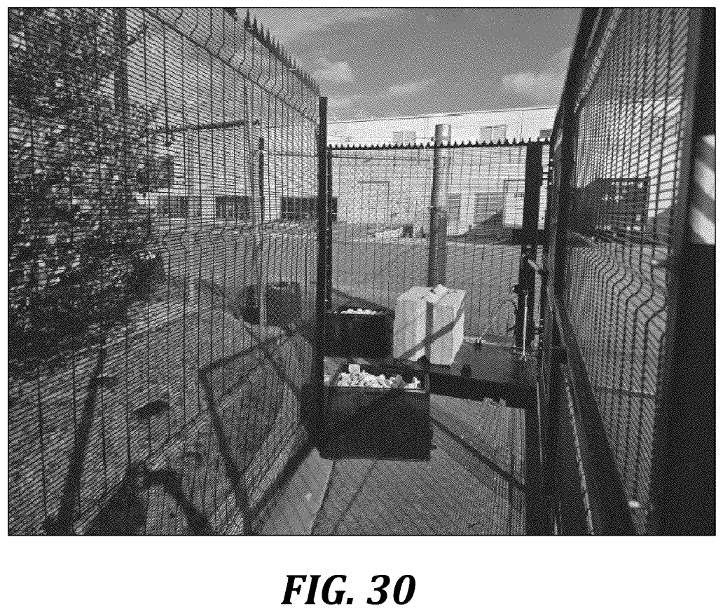

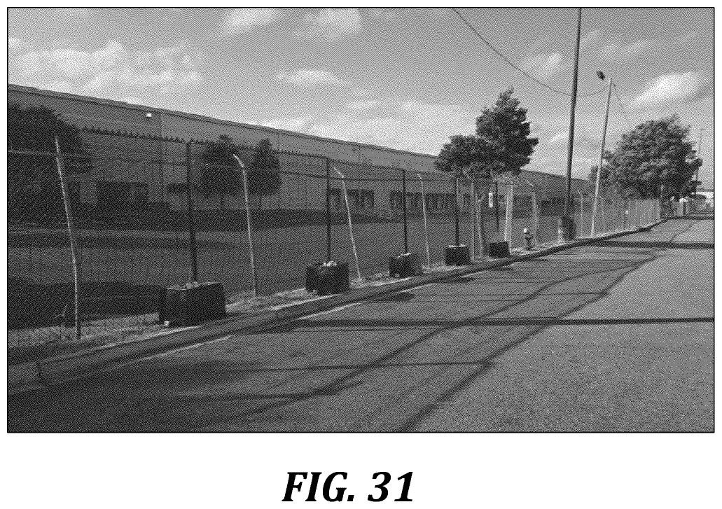

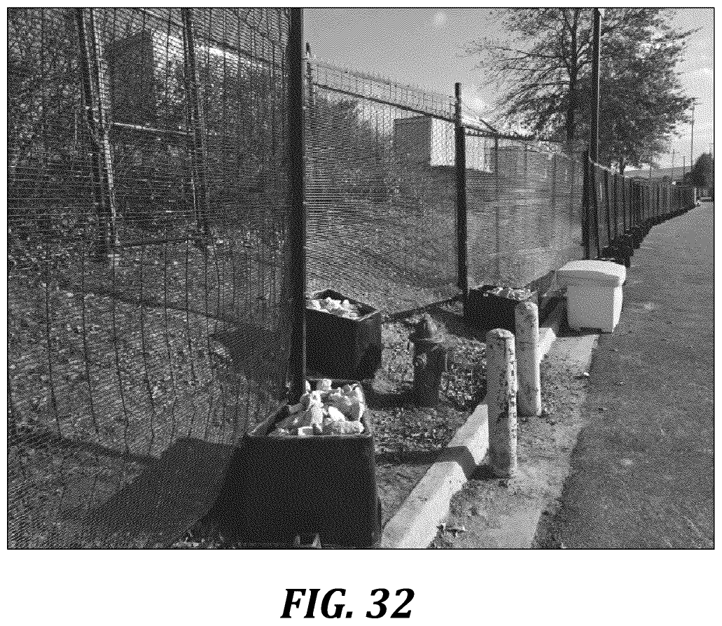

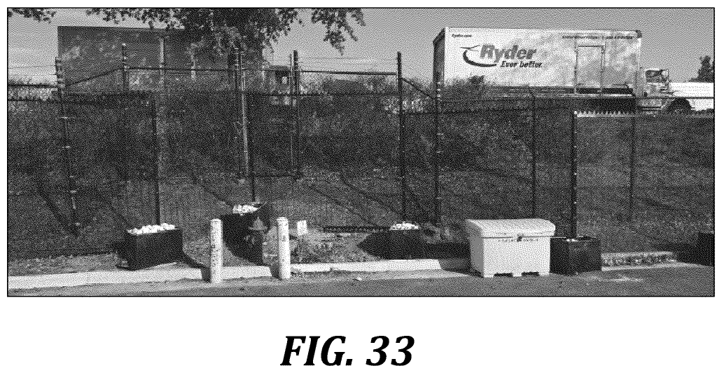

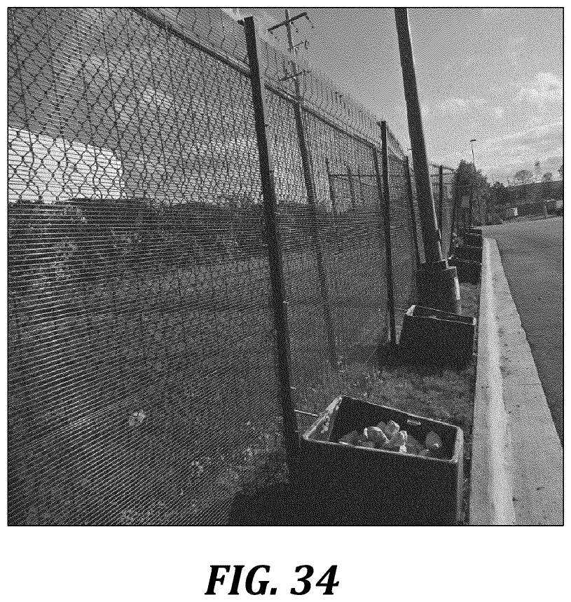

The temporary ballast assembly 500 will next be described with reference to FIGS. 13-34. The temporary ballast assembly 500 is generally configured to enable a heavy substance, such as rocks or gravel, to be temporarily used to provide stability to the temporary barrier post 110 in a flexible, simple, and efficient manner. For instance, an empty temporary ballast assembly 500 can be positioned around the perimeter of a work site or other secure location to define a perimeter for the installation of a temporary barrier system. Minor position and location adjustments may be performed to the lightweight, empty temporary ballast assemblies 500. Once the positions have been defined by the plurality of empty temporary ballast assemblies 500 dispatched throughout the locale, a temporary barrier system can be installed. More specifically, a heavy substance can be added to the temporary ballast assemblies 500 to secure them in place and provide stability to the temporary barrier system.

One major advantage of this configuration is that a worksite can be prepared with relative ease before heavy machinery delivers heavy components. A further advantage is that a heavier ballast load can be used for each segment of the temporary barrier system than would be possible for a traditional barrier system, such as one using metal plates as support ballast for chain link fencing. In traditional systems, ballast weight is limited by the need to enable installers to position the system on site, leading to compromised security. The temporary ballast assemblies 500 described herein can be both installed quickly and efficiently and provide additional security to the barrier system. Yet another advantage is that, when the temporary barrier system is no longer required, the temporary barrier system can be disassembled, and the heavy substance can be easily removed from the temporary ballast assemblies 500. Such temporary ballast assemblies 500 can then be moved for storage or for installation at another location.

In the depicted example, the temporary ballast assembly 500 generally includes a container body 502 defining a ballast receptacle 504 for receiving and retaining ballast, a first post-receiving receptacle member 506 secured to the container body 502 and configured to removably receive a temporary barrier post (such as temporary barrier post 110) in one of a plurality of positions relative to vertical, and a post mounting assembly configured to facilitate coupling of a temporary barrier post (such as temporary barrier post 110) to the container body 502 in each of the plurality of positions relative to vertical.

The container body 502 will first be described in detail. The container body 502 includes a plurality of side wall 518 and a floor 520 that collectively define the ballast receptacle 504. The volume of ballast receptacle 504 is selected so as to receive adequate ballast to provide stability to a corresponding temporary barrier post 110. In some examples, the ballast receptacle 504 may contain between about 1 to about 6 cubic feet of material, between about 1 to about 5 cubic feet of material, from about 1 to about 4 cubic feet of material, or from about 2 to about 3 cubic feet of material. Accordingly, when filled with gravel or the like, the ballast receptacle 504 may contain about 200 pounds of ballast, about 300 pounds of ballast, about 400 pounds of ballast, or about 500 pounds of ballast.

The plurality of side wall 518 comprise a first side wall 518a, a second side wall 518b, a third side wall 518c, and a fourth side wall 518d. While a four-sided container body 502 is described for clarity, it is to be understood that additional numbers of side walls are possible and fall within the scope of the present disclosure, such as a container body 502 containing five side walls, six side walls, seven side walls, or more.

Each side wall 518 of the plurality of side walls 518 comprises an inner portion 526 (defining the ballast receptacle 504), an outer portion 512 (defining an exterior of the container body 502), which extend between a base 528 and an upper rim portion 530. The inner portions 526 of each side wall 518 extend generally towards a center of the container body 502, and the outer portions 512 of each side wall 518 extend generally away from a center of the container body 502. Specifically, the interior of the container body 502 generally decreases in cross-sectional size from the upper rim portion 530 of the container body 502 to the base 528 of the container body 502. Such a tapered interior helps facilitate dumping of ballast from the ballast receptacle 504, enabling ballast flow.

At the same time, the outer portion 512 of the container body 502 generally increases in cross-sectional size from the upper rim portion 530 of the container body 502 to the base 528 of the container body 502. The outwardly extending outer portion 512 improves the stability of the temporary ballast assembly 500 by lowering the center of gravity for the temporary ballast assembly 500. The inwardly extending inner portion 526 and outwardly extending outer portion 512 design also supports efficient nesting or stackability of a set of temporary ballast assemblies 500 for convenient storage and transportation. The stackability is efficient, for example, because the corresponding portions of the flared inner portion 526 and outer portion 512 define a receiving gap at the base 528 of the container body 502 that is relatively wide compared to the width of upper rim portion 530 of the container body 502. Accordingly, stacking of one container body 502 on a second container body 502 does not require the careful alignment of walls, such as would be required when stacking a container where the side walls are substantively perpendicular to a base portion of a container. Thus, when a first container body 502 is stacked on a second container body 502, the outer portion 512 of the first container body 502 is proximate the outer portion 512 of the second container body 502, and the inner portion 526 of the first container body 502 is proximate the inner portion 526 of the second container body 502.

Container body 502 may be defined by an injection molded polymer material of a suitable thickness and resistance to strain in order to hold and transport a required volume of ballast, such as gravel. In some examples, the container body 502 includes internal reinforcement, such as that provided by reinforcement fibers, a metal mesh material, or any other internal reinforcement features suitable for increasing the durability and strength of injection molded polymer materials. Thus, the material of container body 502 is configured to be resistant to damage from the abrasive action of repeated filling with ballast and dumping of said ballast.

As noted above, in the illustrated example, the temporary ballast assembly 500 is configured to be stackable, such as where the inner portion of a first temporary ballast assembly 500 is nested within an outer portion of a second temporary ballast assembly 500. An advantage of this feature is that many temporary ballast assemblies 500 may be stacked during transport from a warehouse or storage facility to a worksite, thus increasing the number of temporary ballast assemblies 500 that can be delivered for a particular cargo footprint area.

In the depicted example, the temporary ballast assembly 500 includes a plurality of spacers 510 formed on an outer portion 512 of the container body 502. The spacers 510 are configured to substantially prevent container bodies 502 from sticking when stacked. Without being bound by theory, when nested containers are typically stacked, the combined weight can cause compression between subsequent containers in the stack. This can cause containers to become stuck as an inner nested container presses against an outer nested container. By using a plurality of spacers 510, the contact area between an inner and outer nested container is minimized, thus preventing a buildup of friction that results in sticking between containers. In some examples, an angle of a slope of spacers 510 with respect to vertical is less than an angle of a slope of the inner walls of the container body 502 with respect to vertical. In this manner, the spacers 510 may act as a shelf for a top container resting on a bottom container such that the walls between the two containers have a gap when nested.

The temporary ballast assembly 500 may also include a container lifting assembly 514 configured to facilitate both moving and emptying of the temporary ballast assembly 500. In the depicted example, the container lifting assembly 514 is defined by optimally located slots or other openings that are configured to secure first and second lifting straps (not illustrated) to opposite sides of the container body 502. The straps may be secured to a lifting device or moving equipment, such as forks of a forklift. For example, the first and second lifting straps can be coupled to the container body 502 of the temporary ballast assembly 500 by E-Tracks, allowing the temporary ballast assembly 500 to readily interface with commonly used tie-down accessories for ease of transport and dumping.

In some examples, the temporary ballast assembly 500 is further configured so that one of the first and second lifting straps can be selectively released so as to enable dumping of the ballast 516 from the container body 502. Dumping may be accomplished by manipulating the first and second lifting straps such that, when attached, the container body 502 tips to one side, thereby dumping any ballast 516 contained therein. By comparison, a system with built-in forklift receiving slots cannot be used for emptying the temporary ballast assembly 500.

An additional advantage of the container lifting assembly 514 including detachable first and second lifting straps are that they simplify the design of the outer portion 512 of the container body 502. For example, a prior art system with built-in forklift receiving slots will necessarily include additional external features, including ridges or hollow openings, so that there is space to receive forks of a forklift. To allow for lifting of a heavy weight, such forklift receiving slots are typically formed near a bottom edge, and will be formed with sharply defined features so as to allow the container to rest on the ground and still have space to receive forks of a forklift. These external features along a working edge introduce the risk of chipping or breakage due to the presence of the protruding and sharply defined features. By instead including embedded slots for receiving detachable first and second lifting straps, there are fewer exposed edges that can be broken during movement and assembly of the temporary barrier system.

The first post-receiving receptacle member 506 secured to the container body 502 and configured to removably receive a temporary barrier post (such as temporary barrier post 110) in one of a plurality of positions relative to vertical will now be described. In the illustrated example, the first post-receiving receptacle member 506 is located exterior of the container body 502 side walls 518 and is disposed on a primary coupling tab 522 protruding laterally from a side wall 518 of the container body 502. The primary coupling tab 522 may be configured to lie generally flat against a ground surface, with the plane of the primary coupling tab 522 generally co-planar with a bottom flat edge of the base 528 of the container body 502. The first post-receiving receptacle member 506 is defined within the primary coupling tab 522 in a manner that allows for a temporary barrier post, such as temporary barrier post 110, to interface with a side of the temporary ballast assembly 500.

In the illustrated example, the primary coupling tab 522 extends from a side wall 518 of the container body 502. The primary coupling tab 522 may be substantively centered along the base 528 of the first side wall 518a, as shown. The first side wall 518a has a length that is greater than a length of the second side wall 518b, where the first side wall 518a and second side wall 518b are formed on opposite (e.g., front and back) sides of the container body 502. The length of the opposing third side wall 518c and fourth side wall 518d are each greater in length than the first side wall 518a.

Without being bound by theory, this configuration has the advantage of placing the first post-receiving receptacle member 506 adjacent to the widest and thus heaviest portion of the temporary ballast assembly 500. The elongated aspect ratio further allows suitable amounts of ballast to be positioned further from the first post-receiving receptacle member 506, which acts to prevent tipping of the temporary barrier panels due to the application of force farther from the fulcrum point of the temporary barrier system. It also has the advantage of allowing the second side wall 518b of the temporary ballast assembly 500 to be the narrowest portion of the temporary ballast assembly 500, thus increasing the space between adjacent temporary ballast assemblies 500 when installed as part of a temporary barrier system. For example, when installed in a parking lot, adjacent temporary ballast assemblies 500 can be positioned substantively along the parking spot lines, and the narrow footprint of the temporary ballast assembly 500 thus allows cars to continue to park in the parking spots to improve efficiency of space used.

The primary coupling tab 522 may further include one or more primary ground coupling points 524 configured to couple the container body 502 to a first portion of ground via a first ground anchor(s). For instance, the primary coupling tab 522 may include one or more through-holes for receiving a ground anchor(s) therein. In some examples, the first ground anchor is a ground screw, a spike, or a piece of rebar. Thus, when desired, additional support can be provided to a temporary barrier system to maintain the structural integrity of said temporary barrier system, such as to prevent slipping of the temporary ballast assembly 500 across a section of the ground.

In some examples, the first ground anchor is selected so as to not require a permit for installation. In some examples, the first ground anchor is a permanent installation ground anchor, thus allowing for more permanent installation of the temporary barrier system. In some examples, the temporary ballast assembly 500 is removable from the temporary barrier system and a permanent attachment means can be installed in its place. For example, the temporary barrier post 110 may be converted to a permanent installation by de-coupling the temporary ballast assembly 500 from a temporary barrier post 110, decoupling the temporary barrier post 110 from the temporary barrier panel 120, and installing a permanent barrier post anchored in a portion of the ground. The permanent barrier post may then be coupled to the temporary barrier panel 120, thus converting the temporary barrier system 110 into a permanent barrier system.

In some examples, a secondary coupling tab 540 protrudes laterally from the base 528 of the outer portion 512 to provide additional anchoring capabilities. In the example shown, the secondary coupling tab 540 protrudes laterally from the second side wall 518b of the container body 502 and may be generally co-planar with a bottom flat edge of the base 528 of the container body 502. The secondary coupling tab 540 is also substantively centered along the second side wall 518b. The secondary coupling tab 540 includes one or more secondary ground coupling points 542, e.g., holes, configured to couple the secondary coupling tab 540 to a second portion of ground via a second ground anchor. In this manner, additional support can be provided to prevent shifting or slipping of the temporary ballast assembly 500. In some examples, additional coupling tabs can be installed in additional locations around the base 528 of the temporary ballast assembly 500.

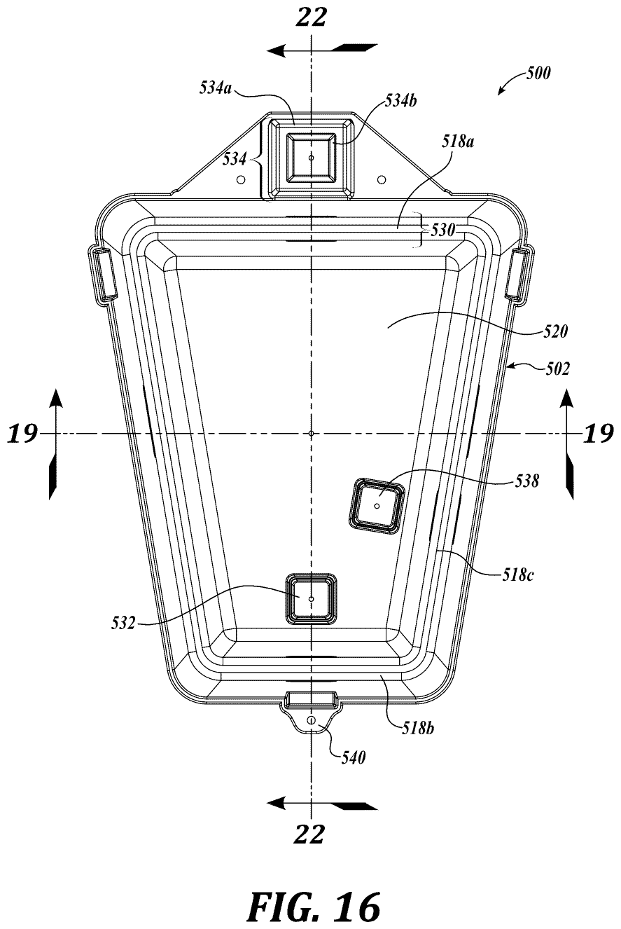

As noted above, the temporary ballast assembly includes a first post-receiving receptacle member 506 secured to the container body 502 and configured to removably receive the temporary barrier post 110 in one of a plurality of positions relative to vertical. The temporary ballast assembly 500 may further include a second post-receiving receptacle member 532 located interior of the container body 502 side walls 518 and on the floor 520 of the container body 502, as is best depicted in FIG. 16. The temporary ballast assembly 500 may also include a third post-receiving receptacle member 538 also located interior of the container body 502 side walls 518 and on the floor 520 of the container body 502. The second post-receiving receptacle member 532 is shown proximate the second side wall 518b, and the third post-receiving receptacle member 538 is shown proximate the third side wall 518c.

The cross-sectional dimensions of the first post-receiving receptacle member 506 may be larger than either of second post-receiving receptacle member 532 or third post-receiving receptacle member 538, the dimensions of first post-receiving receptacle member 506 may be the same as either second post-receiving receptacle member 532 or third post-receiving receptacle member 538, or the dimensions of first post-receiving receptacle member 506 may be the same as both second post-receiving receptacle member 532 and third post-receiving receptacle member 538. Without being bound by theory, the second post-receiving receptacle member 532 and third post-receiving receptacle member 538 may be constructed with smaller cross-sectional dimensions because the temporary barrier post installed therein will be additionally secured by the ballast 516 that will substantially surround the temporary barrier post when installed, thus preventing slippage.

The first post-receiving receptacle member 506, second post-receiving receptacle member 532, and third post-receiving receptacle member 538 may be similar in construction to the container body 502, having sloped interior and exterior side walls. In that regard, each of the first post-receiving receptacle members 506, 532, and 538 have a receptacle body 534 that is substantially tapered in cross-sectional size as it extends from a top open end 534a towards a bottom closed end 534b. When any of first post-receiving receptacle member 506, second post-receiving receptacle member 532, or third post-receiving receptacle member 538 receive a temporary barrier post, such as temporary barrier post 110, the interior tapering of the receptacle body 534 allows for the temporary barrier post to be adjusted relative to a vertical axis. In this way, the temporary barrier post can be repositioned so that the positions relative to vertical of the temporary barrier post can be adjusted regardless of ground terrain, thus allowing for installation of a temporary barrier system along or against the slope of a hill while still maintaining a desired vertical orientation of temporary barrier panel 120.

Without being bound by theory, an advantage of including both a first post-receiving receptacle member 506 on a primary coupling tab 522, and a second post-receiving receptacle member 532 and a third post-receiving receptacle member 538 located interior of the container body 502 side walls 518 is to allow the container body 502 to be positioned in any orientation relative to the temporary barrier post 110 and/or temporary barrier panels 120. For example, container body 502 can be oriented so that the third side wall 518c and fourth side wall 518d run parallel to the temporary barrier panels, thus minimizing the amount to which the temporary ballast assembly 500 protrudes away from the temporary barrier system.

On the other hand, the container body 502 can be oriented so that the second side wall 518b is adjacent to the temporary barrier panels 120, thus placing additional weight away from the fulcrum point of the temporary barrier system and improving the resistance of the temporary barrier system to tipping. Moreover, in some examples, installation of the temporary barrier system 100 using the first post-receiving receptacle member 506 located external the container body 502 can be advantageous when rapid installation is a priority, while installation of the temporary barrier system using the second post-receiving receptacle member 532 or third post-receiving receptacle member 538 can be advantageous when additional structural support against toppling is desired by substantively surrounding each of the temporary barrier posts with ballast.

The post mounting assembly that is configured to facilitate coupling of a temporary barrier post (such as temporary barrier post 110) to the container body 502 in each of a plurality of positions relative to vertical will now be described. In the depicted example, the post mounting assembly is defined by at least one slot 508 configured to adjustably receive a fastener 536. For example, a slot 508 can be defined in the container body 502 proximate the upper rim portion 530 of the container body 502, which may be a thickest portion of the container body 502 to provide a secure attachment point.

The slot 508 of the post mounting assembly may be generally horizontally oriented to enable an installer to adjust the horizontal positioning of a temporary barrier post 110 relative to the container body 502. As can be appreciated, as a temporary barrier post 110 is moved within a post-receiving receptacle member relative to vertical, the attachment location on the container body 502 will change horizontally.

In some examples, the fastener 536 may be a threaded rod securable within the slot 508 via a threaded adjustment nut. The threaded rod may also be couplable to a temporary barrier post 110. After passing through both a temporary barrier post 110 and a slot 508, a threaded adjustment nut may be secured on an end of the fastener 536 so that the nut presses against the inner portion 526 of the side wall 518 proximate the at least one slot. For instance, the threaded adjustment nut may press against the inner portion 526 of the first side wall 518a when the temporary barrier post 110 is engaged with the first post-receiving receptacle member 506. Similarly, the threaded adjustment nut may press against the inner portion 526 of the second side wall 518b when the temporary barrier post 110 is engaged with the second post-receiving receptacle member 532. Moreover, the threaded adjustment nut may press against the inner portion 526 of the third side wall 518c when the temporary barrier post is engaged with the third post-receiving receptacle member 538. By using a threaded rod and threaded adjustment nut, an additional advantage is that an installer can adjust the fore/aft positioning of the temporary barrier post 110 relative to the container body 502, thus enabling the system to maintain ballast for the post at a plurality of positions relative to vertical.

Turning to FIG. 24 and FIG. 25, an exemplary assembly for securing one or more temporary barrier panels 120 to the one or more temporary barrier posts 110 will now be described. In the example shown, a plurality of clips 600 are used to support efficient coupling of the temporary barrier panels 120 to the temporary barrier posts 110. In the illustrated example, the clips 600 each include a generally planar clip body 601 formed to define a generally cubical receiving volume 606. The generally cubical receiving volume 606 is configured to receive an end of a temporary barrier post, such as temporary barrier post 110. At least one side of the generally planar clip body 601 includes one or more clip-to-post coupling points or openings 602, which allow for easy coupling of the clips 600 to the temporary barrier posts, such as with fasteners. In some examples, the clips 600 do not couple to the temporary barrier posts, and instead rest on top of the post and are held in place by friction. In this example, an advantage of a clip 600 held in place by friction is that installation can proceed with significant time savings and require less hardware. Such a design also increases speed and simplifies assembly of the temporary barrier panels 120 to the temporary barrier posts 110.

Each clip 600 further includes one or more clip-to-barrier panel coupling points 604. Each clip-to-barrier panel coupling point 604 is configured to receive or otherwise couple to a portion of a temporary barrier panel 120, such as a horizontal portion of mesh. In that regard, each clip-to-barrier panel coupling point 604 may be defined by an upturned curved lip extending from an edge of the generally planar clip body 601 that is generally sized and shaped to receive a horizontal portion of a temporary barrier panel 120.

As best seen in FIG. 25, during installation, a plurality of temporary barrier posts 110 can be attached to a plurality of temporary ballast assemblies 500 (not shown), as described above. Once the temporary barrier posts 110 and the temporary ballast assemblies 500 are properly positioned at a spacing to receive a temporary barrier panel 120, a clip 600 may be secured to the end of each temporary barrier post 110. Thereafter, temporary barrier panels 120 can be quickly hung from the clip-to-barrier panel coupling point 604 of the clips 600. Further attachment points between the temporary barrier panel 120 and the temporary barrier post 110 can then be installed to securely affix the temporary barrier panel 120 to the temporary barrier post 110. For instance, threaded rods and bolts (not illustrated) may additionally be used to affix the temporary barrier panel 120 to the temporary barrier post 110 at additional points along the length of the temporary barrier post 110. In some examples, the clips 600 can thereafter be removed.

It is to be understood that the means of coupling temporary barrier panels to temporary barrier posts is not limited to the illustrated clips 600, and that other means for rapid installation of temporary barrier panels to installed temporary barrier posts are within the scope of the present disclosure. For instance, a plurality of hooks may be installed along the length of the temporary barrier post 110. The hooks may be securable within slotted engagement points in the temporary barrier panels to directly secure the panels to the temporary barrier posts without secondary attachment means.

The detailed description set forth above in connection with the appended drawings, where like numerals reference like elements, are intended as a description of various examples of the present disclosure and are not intended to represent the only examples. Each example described in this disclosure is provided as a representative example or illustration and should not be construed as preferred or advantageous over other examples. The representative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the examples disclosed herein are non-limiting, and the inventors contemplate that other examples within the scope of this disclosure may include structures and functionalities from more than one specific example shown in the figures and described in the specification. That is, the present disclosure includes examples that combine features from different examples.

In the foregoing description, specific details are set forth to provide a thorough understanding of exemplary examples of the present disclosure. It will be apparent to one skilled in the art, however, that the examples disclosed herein may be practiced without embodying all the specific details. In some instances, well-known process steps have not been described in detail in order not to unnecessarily obscure various aspects of the present disclosure. Further, it will be appreciated that examples of the present disclosure may employ any combination of features described herein.

In the detailed description herein, references to “one example”, “an example”, “one or more examples, etc., indicate that the example described may include a particular feature, structure, or characteristic, but every example may not necessarily include the particular feature, structure, or characteristic. Moreover, such phrases are not necessarily referring to the same example. In addition, when a particular feature, structure, or characteristic is described in connection with an example, it is submitted that it is within the knowledge of one skilled in the art to affect such feature, structure, or characteristic in connection with other examples whether or not explicitly described. After reading the description, it will be apparent to one skilled in the relevant art(s) how to implement the disclosure in alternative examples. Thus, it will be appreciated that examples of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

In the claims and for purposes of the present disclosure, the terms “a”, “an”, “the”, and the like, refer to the singular and the plural forms of the object or element referenced.

The present application may include references to directions, such as “vertical,” “horizontal,” “front,” “rear,” “left,” “right,” “top,” and “bottom,” etc. These references, and other similar references in the present application, are intended to assist in helping describe and understand the particular example (such as when the example is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative examples, and modes of operation of the present disclosure have been described in the foregoing description. However, aspects of the present disclosure, which are intended to be protected, are not to be construed as limited to the particular examples disclosed. Further, the examples described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A temporary gate module for a temporary barrier system, the temporary gate module comprising:
a temporary gate unit; and
one or more ballast units configured to be fixedly coupled to the temporary gate unit, the one or more ballast units comprising:
a base portion having a mass that stabilizes the temporary gate unit when secured thereto;
at least one lifting feature defined along a bottom of the base portion;
a plurality of guide posts disposed along a top of the base portion;
a mounting bracket configured to detachably couple the base portion to the temporary gate unit, the mounting bracket comprising:
a base coupling portion configured to adjustably receive the plurality of guide posts; and
a gate coupling portion configured to fixedly couple the mounting bracket to the temporary gate unit.

2. The temporary gate module of claim 1, wherein the at least one lifting feature includes a pair of slots defined along a bottom of the base portion, said pair of slots being configured to accept a pair of forklift forks.

3. The temporary gate module of claim 1, wherein the weight ratio of the one or more ballast units to the temporary gate unit is about between about 7:1 and about 13:1.

4. The temporary gate module of claim 1, wherein the one or more ballast units comprises poured concrete.

5. The temporary gate module of claim 1, wherein the base coupling portion of the mounting bracket is vertically adjustable relative to the base portion.

6. The temporary gate module of claim 1, wherein the mounting bracket further comprises a post coupling portion configured to receive a pedestrian gate post.

7. The temporary gate module of claim 6, wherein the gate coupling portion and the post coupling portion are, when coupled to the base portion, raised relative to the base coupling portion.

8. The temporary gate module of claim 1, wherein the mounting bracket comprises a first mounting bracket and a second mounting bracket.

9. The temporary gate module of claim 8, wherein the first mounting bracket and the second mounting bracket are substantially identical.

10. The temporary gate module of claim 8, wherein the first mounting bracket is configured to couple to the temporary gate unit.

11. The temporary gate module of claim 8, wherein the first mounting bracket and the second mounting bracket comprise one or more level adjustment members.

12. The temporary gate module of claim 1, wherein the temporary gate unit comprises a door frame and a door.

13. The temporary gate module of claim 8, wherein the door is a bi-directional door.

14. The temporary gate module of claim 1, wherein the temporary gate module further comprises one or more pedestrian gate posts.

15. A temporary gate module for a temporary barrier system, the temporary gate module comprising:
a temporary gate unit; and
one or more ballast units configured to be fixedly coupled to the temporary gate unit, the one or more ballast units comprising:
a molded block portion having a mass that stabilizes the temporary gate unit when secured thereto; and
a plurality of guide posts extending laterally from the molded block portion and configured to be adjustably coupled to a block coupling portion of the temporary gate unit in at least one of a vertical and horizontal position.

16. (canceled)

17. (canceled)

18. The temporary gate module of claim 15, wherein the temporary gate unit comprises a vehicle gate comprising a gate length and a vehicle gate mounting post, wherein the vehicle gate mounting post comprises the block coupling portion.

19. (canceled)

20. A temporary barrier system comprising:
one or more of the temporary gate modules of claim 1;
one or more temporary ballast assemblies;
one or more temporary barrier posts configured to couple to the one or more temporary ballast assemblies;
one or more temporary barrier panels configured to couple to the one or more temporary barrier posts; and
one or more clips configured to couple the one or more temporary barrier panels to the one or more temporary barrier posts.

21. (canceled)

22. (canceled)

23. The temporary barrier system of claim 20, wherein the temporary ballast assembly comprises:
a container body defining a ballast receptacle for receiving and retaining ballast;
a first post-receiving receptacle member secured to the container body and configured to removably receive the temporary barrier post in one of a plurality of positions relative to vertical; and
a post mounting assembly configured to facilitate coupling of the temporary barrier post to the container body in each of the plurality of positions relative to vertical.

24. (canceled)

25. A temporary barrier system comprising:
one or more of the temporary gate modules of claim 15;
one or more temporary ballast assemblies;
one or more temporary barrier posts configured to couple to the one or more temporary ballast assemblies;
one or more temporary barrier panels configured to couple to the one or more temporary barrier posts; and
one or more clips configured to couple the one or more temporary barrier panels to the one or more temporary barrier posts.

26-28. (canceled)

29. A temporary gate module for a temporary barrier system, the temporary gate module comprising:
one or more ballast units; and
a gate unit configured to be fixedly coupled to the one or more ballast units.
